(19) United States
(12) Patent Application Publication
(10) Pub. No.: US 2013/0231793 A1
(43) Pub. Date: Sep. 5, 2013

(54) RELAY SYSTEM WITH BRANCH CIRCUIT METERING

(71) Applicants: Randall B. Elliott, Tigard, OR (US); Subramanian Muthu, Portland, OR (US); David Bruno, Portland, OR (US)

(72) Inventors: Randall B. Elliott, Tigard, OR (US); Subramanian Muthu, Portland, OR (US); David Bruno, Portland, OR (US)

(73) Assignee: LEVITON MANUFACTURING CO., INC., Melville, NY (US)

(21) Appl. No.: 13/410,106

(22) Filed: Mar. 1, 2012

(51) Int. Cl. G05F 5/00

(52) U.S. Cl. 700/292

(57) ABSTRACT

A networked lighting control device may include a switching device to control power to a load, a communication interface to couple the relay module to a control module at the relay panel, revenue-grade metering circuitry to monitor power flowing to the load, and a controller to control the switching device in response to inputs received at the communication interface and to transmit metrology data to the control module. A control module may include a mounting interface to mount the control module to a relay panel, a first communication port to receive first control inputs using a first protocol, a second communication port to receive second control inputs using a second protocol, a third communication port to control one or more relay modules mounted to the relay panel using the local communication format, and logic to translate the first and second control inputs to the local communication format.

### BACKGROUND

Relay panels are used to control lights, fans, and other electrical loads in response to manual and automatic inputs. A typical relay panel includes multiple relay modules, each of which is wired in a branch circuit, that is, between the final over current protection device and the corresponding load or loads. A control module in the relay panel controls each relay module in response to a designated input. For example, a control module may be configured to turn certain relays, and thus their corresponding loads, on or off in response to a manual low-voltage switch input, while other relays are turned on or off in response to occupancy sensors or photocells. A control module in a relay panel may also be configured to control relay modules in response to commands received over a communication network.

Some prior art relay modules include built-in current and/or voltage sensing capabilities. For example, a relay module may include a current sensor that provides some measure of the current flowing through the relay contacts, and enables the relay module to report the measured current back to the control module. This current sensing and reporting capability may be used, for example, to enable the control module to identify a branch circuit having a burned-out lamp, and then report the burned-out lamp to a building maintenance department. As another example, the peak current through a relay module may be measured to identify and report overloads or other problems on a branch circuit. Likewise, prior art relay modules may also include voltage sensing circuitry to identify and report over- or under-voltage conditions, overloads, brown-outs, etc.

Prior art relay modules typically utilize rudimentary average or RMS current and voltage measurement techniques, which are adequate for the applications discussed above. Some prior art relay systems attempt to utilize the existing current and/or voltage sensing capabilities that are built in to prior art relay modules to monitor the flow of power through various branch circuits in a building electrical system. These systems attempt to measure power by multiplying the measured relay current by the measured relay power. However, because the voltage and current measurements are rudimentary and/or uncorrelated, this only provides an estimation or apparent power rather than a measure of the true power of the load controlled by the relay. Moreover, the power computations must be performed in the control module or other centralized data collection location. The relay modules only obtain rudimentary measurements which are transmitted to the control module or other centralized location for further processing.

### BRIEF DESCRIPTION OF THE DRAWINGS

FIG. 1 illustrates an embodiment of a relay panel system having multi-protocol functionality according to some inventive principles of this patent disclosure.

FIG. 2 illustrates an embodiment of a relay panel having a control module with multi-protocol functionality according to some inventive principles of this patent disclosure.

FIG. 3 illustrates an embodiment of a relay panel system having revenue-grade metering according to some inventive principles of this patent disclosure.

FIG. 4 illustrates an embodiment of a relay module having revenue-grade metering according to some inventive principles of this patent disclosure.

FIG. 5 illustrates an exemplary embodiment of a relay module having revenue-grade metering according to some inventive principles of this patent disclosure.

FIG. 6 illustrates an exemplary embodiment of a relay module according to some inventive principles of this patent disclosure.

FIG. 7 illustrates an exemplary embodiment of a sensing circuit according to some inventive principles of this patent disclosure.

FIG. 8 illustrates another exemplary embodiment of a sensing circuit according to some inventive principles of this patent disclosure.

FIG. 9 illustrates another embodiment of a relay module having a metrology processor according to some inventive principles of this patent disclosure.

FIG. 10 illustrates another embodiment of a relay module having a metrology processor according to some inventive principles of this patent disclosure.

FIG. 11 illustrates another embodiment of a relay module having a metrology processor according to some inventive principles of this patent disclosure.

FIG. 12 illustrates another embodiment of a relay module having a metrology processor according to some inventive principles of this patent disclosure.

FIG. 13 illustrates another embodiment of a relay module having a metrology processor according to some inventive principles of this patent disclosure.

FIG. 14 illustrates an embodiment of a DC-DC converter having a communication signal modulated onto the switching signal according to some inventive principles of this patent disclosure.

FIG. 15 illustrates an embodiment of a communication port configuration that uses the start bit of a communication packet to signal a zero crossing according to some inventive principles of this patent disclosure.

FIG. 16 illustrates an embodiment of a timing sequence for using the start bit of a communication packet to signal a zero crossing according to some inventive principles of this patent disclosure.

FIG. 17 illustrates an example embodiment of a method for selectively synchronizing the opening of relay contacts in response to a different type of zero-crossing depending on the load conditions according to some inventive principles of this patent disclosure.

FIG. 18 illustrates an embodiment of a relay module having programmable thresholds for alarms according to some inventive principles of this patent disclosure.

FIG. 19 illustrates another embodiment of a relay module having programmable thresholds for alarms according to some inventive principles of this patent disclosure.

FIG. 20 illustrates an embodiment of a relay panel system having metering data storage according to some inventive principles of this patent disclosure.

FIG. 21 illustrates an embodiment of a relay module having an illuminated actuator according to some of the inventive principles of this patent disclosure.

FIG. 22 illustrates another embodiment of a relay module having an illuminated actuator according to some of the inventive principles of this patent disclosure.

FIG. 23 illustrates an embodiment of a relay system having demand response capabilities according to some inventive principles of this patent disclosure.

FIG. 24 illustrates an embodiment of a control module having demand response logic with various load shedding logic according to some inventive principles of this patent disclosure.

FIG. 25 illustrates a room floor plan for a relatively simple embodiment in which each of three relays controls two identical lighting fixtures according to some inventive principles of this patent disclosure.

FIG. 26 illustrates an embodiment of a hybrid relay module according to some inventive principles of this patent disclosure.

FIG. 27 illustrates an example embodiment of a relay panel system for a building that illustrates some of the inventive principles of this patent disclosure.

### DETAILED DESCRIPTION

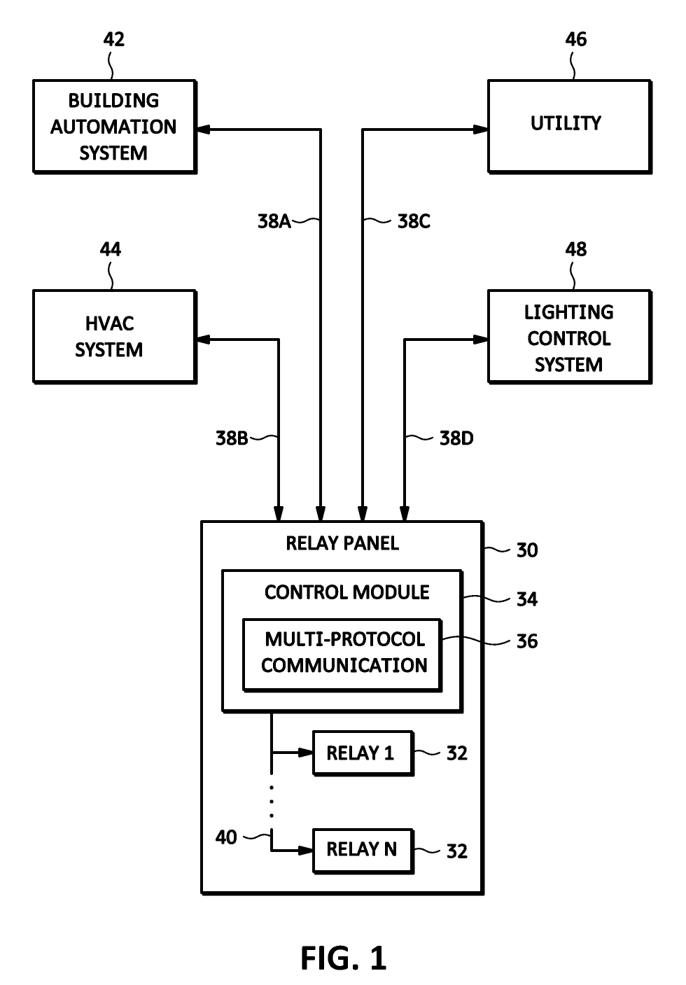

FIG. 1 illustrates an embodiment of a relay panel system having multi-protocol functionality according to some inventive principles of this patent disclosure. The embodiment of FIG. 1 includes a relay panel 30 having one or more mounting locations for relay modules 32 on the relay panel, and a control module 34 mounted to the relay panel and configured to control the relay modules 32.

The control module 34 includes logic 36 to translate inputs 38A-38D in different communication protocols to a local communication format 40 to control the relay modules 32. For example, the communication protocol of the first input 38A may be BACnet for communicating with a building automation system (BAS) 42, the communication protocol for the second input 38B may be Lonworks for communicating with a heating, ventilation and air conditioning (HVAC) system 44, the communication protocol for the third input 38C may be Smart Energy 2.0 over a ZigBee physical network or Open Automated Demand Response Communication Standards (OpenADR) for demand response communications with a utility 46, and the communication protocol for the fourth input 38D may be a Luma-Net® protocol for communicating with a lighting control system 48.

The local communication format for the local control bus 40 may be, for example Modbus protocol over an RS-485 physical network. Alternatively, the communication format may be simple relay coil conductors for turning one or more air-gap relays in the relay modules on and off.

The multi-protocol logic 36 in the control module 34 is capable of translating inputs from any of these or other suitable protocols into the Modbus protocol or other suitable communication format for controlling the relay modules 32.

The embodiment of FIG. 1 enables a method that includes receiving first control inputs using a first protocol 38A at the relay panel 30, receiving second control inputs using a second protocol 38B at the relay panel, translating the first control inputs to a local communication format for a local control bus 40 at the relay panel, translating the second control inputs to the local communication format at the relay panel, and controlling one or more relays 32 at the relay panel in response to the first and second control inputs using the local communication format.

The relay panel 30 as well as any of the other relay panels in this patent disclosure may be installed downstream of a circuit breaker panel, for example, in an electrical or utility room, in a common area of a building, or in any other suitable location.

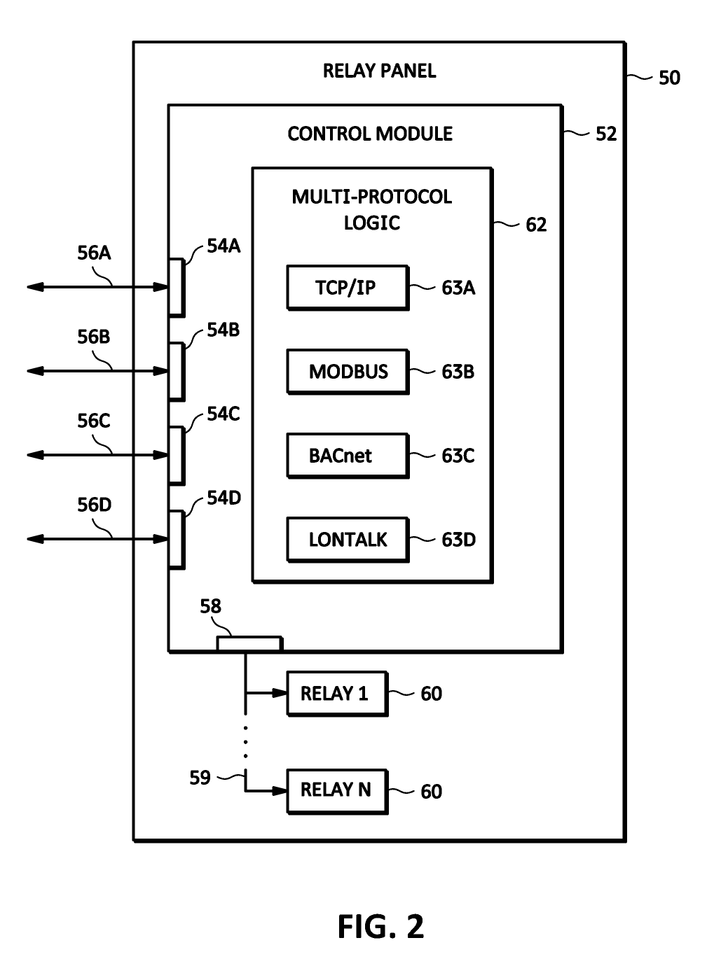

FIG. 2 illustrates an embodiment of a relay panel having a control module with multi-protocol functionality according to some inventive principles of this patent disclosure. The relay panel 50 of FIG. 2 includes a control module 52 having a mounting interface (not shown) to mount the control module to the relay panel 50, multiple communication ports 54A-54D to receive control inputs 56A-56D using a multiple protocols, and another communication port 58 to control one or more relays 60 mounted to the relay panel using a local communication format on a local control bus 59. The control module 52 also includes logic 62 to translate the protocols of the control inputs to the local communication format.

The mounting interface to mount the control module 52 to the relay panel 50 may include any suitable apparatus. For example, the mechanical portion of the interface may include mounting tabs on the relay panel and corresponding slots on the control module, fasteners such as screws or mounting posts, etc. The electrical portion of the interface may include wire leads, terminal blocks and/or connectors to make electrical connections between the control module and other components.

Examples of the protocols that may be translated by the multi-protocol logic 62 include TCP/IP (63A), Modbus (63B), BACnet (63C), Lontalk (63D), Smart Energy 2.0, Luma-Net, LumaCAN, etc. Examples of physical networks that the protocols may be transmitted over include Ethernet, ZigBee, RS-485, RS-232, etc.

The multi-protocol logic 62 may be implemented with digital or analog hardware, software, firmware, or any suitable combination thereof. The multi-protocol logic 62 may translate simple on-off commands or dimming commands for individual relays from any of the communication protocols to the local communication format required to control the relay modules. The multi-protocol logic 62 may also translate commands for implementing more complicated “behaviors” that control relay modules based on inputs from occupancy sensors, photocells, time-of-day clocks, astronomical (seasonal) clocks, etc., with rules implemented in other logic in the control module.

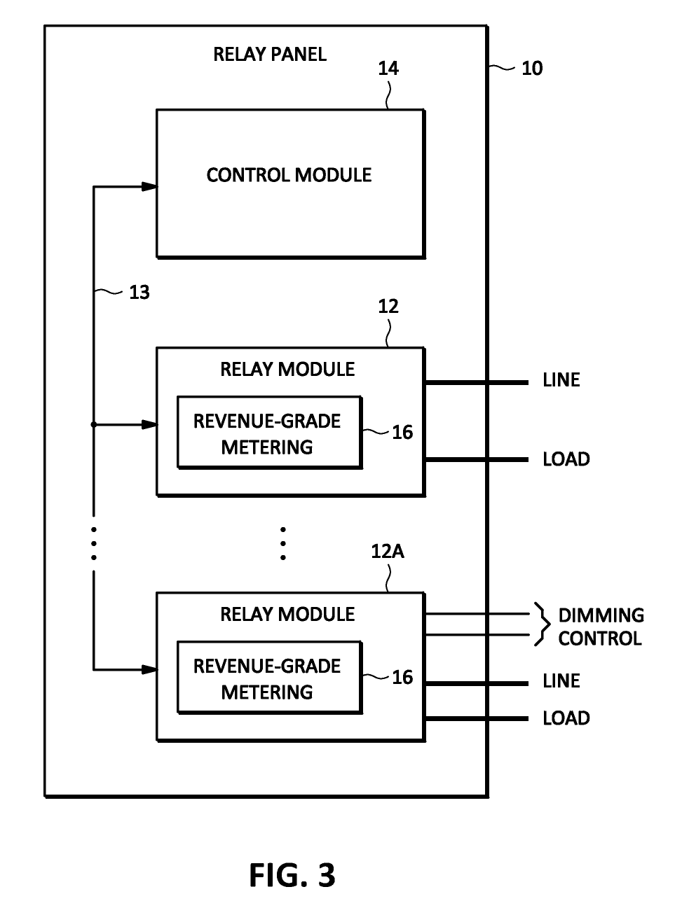

FIG. 3 illustrates an embodiment of a relay panel system having revenue-grade metering according to some inventive principles of this patent disclosure. The system of FIG. 3 includes a relay panel 10, one or more relay modules 12 (which includes variants such as 12A) mounted to the relay panel at relay mounting locations, and a control module 14 mounted to the relay panel at a control module mounting location and configured to control the relay modules 12 through a control bus 13. At least one of the relay modules 12 includes a revenue-grade metering circuit 16 to monitor power flowing through the corresponding relay module 12.

The relay modules 12 may be implemented in various forms according to the inventive principles of this patent disclosure. For example, the top relay module 12 shown in FIG. 3 is illustrated as controlling the flow of power between a line connection LINE and a load connection LOAD. The lower relay module 12A, however, also includes circuitry to provide dimming control signals such as a 0-10 volt analog control signal. Including the analog control signal in a relay module with power switching may be especially useful with loads such as conventional 0-10 volt dimming ballasts which typically continue to draw power even when dimmed all the way down to a level that produces no useable light output. The power switch in the relay module may then turn the power to the ballast completely off. In other embodiments, any other suitable combination of power and/or control connections may be included.

The control module 14 may include functionality to make use of the revenue-grade metering data received from the one or more relay modules 12 such as forwarding some or all of the data to a data aggregator, building automation or management system, utility, etc., implementing load shedding and/or demand response plans, reducing energy charges during peak charge periods, implementing time-of-use (TOU) rate plans, etc., turning off power to loads that are malfunctioning, drawing excessive power, left on inadvertently, submetering, etc.

The embodiment of FIG. 3 enables a method that includes controlling power to a load using a relay module 12 at the relay panel 10, controlling the relay module 12 with the control module 14 at the relay panel 10, performing a revenue-grade metering operation at the relay module, and transmitting data generated by the revenue-grade metering operation from the relay module 12 to the control module 14.

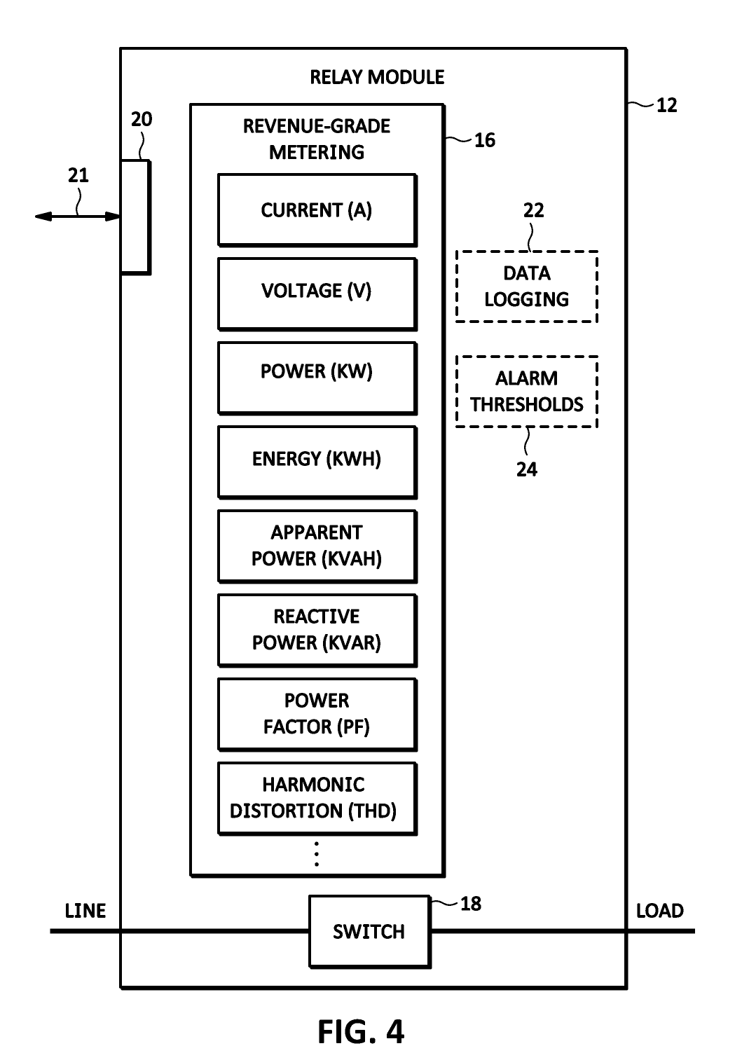

FIG. 4 illustrates an embodiment of a relay module having revenue-grade metering according to some inventive principles of this patent disclosure. The module 12 of FIG. 4 includes a power switching device 18 to control power to a load, a communication interface 20 to couple the relay module 12 to a control module at a relay panel through a control bus 21, and revenue-grade metering circuitry 16 to monitor power flowing to the load. The switching device is controlled in response to inputs received at the communication interface 20, and metering data generated by the revenue-grade metering circuitry 16 is transmitted to the control module through the communication interface 20.

As in the embodiment of FIG. 3, the relay module of FIG. 4 may also include circuitry to provide control outputs in response to commands received through the communication interface such as a 0-10 volt dimming control output, Digital Addressable Lighting Interface (DALI) output, etc. In other embodiments, any other suitable combination of power and/or control connections may be included.

The revenue-grade metering circuitry 16 may include functionality to measure any or all of the following parameters of the power flowing to the load: power in Kilowatts (KW), energy in Kilowatt-hours (KWH), Kilo-volt-amps (or apparent power) (KVA), Kilo-volt-amp-hours (KVAH), reactive power (KVAR), reactive energy (KVARH), volts (V) measured as an average, root-mean-square (RMS), peak, etc., amps (A) measured as an average, root-mean-square (RMS), peak, etc., power factor (PF), total harmonic distortion (THD), peak power, average power, line frequency, and/or any other suitable parameters. As used herein, the term revenue-grade metering refers to metering that is sophisticated enough to determine true power, i.e., Kilowatts, and may be accurate enough for billing purposes when used to measure energy consumption, i.e., Kilowatt-hours. This is in contrast to rudimentary metering that can only determine apparent power based on uncorrelated measurements of voltage and current.

The relay module 12 may also include data logging circuitry 22 to record and store data from the revenue-grade metering circuitry 16 over any suitable period of time. For example, the data logging circuitry 22 may log data for a relatively short period of time, e.g., 15 minutes, then periodically upload the data to a control module or data aggregator in batches.

The relay module 12 may further include alarm circuitry 24 to compare any parameter of interest to one or more thresholds and then send an alarm notification through the communication interface, log an alarm event, or take any other suitable action in response to the parameter reaching a threshold. The thresholds may be received through the communication interface 20 and stored locally at the relay module 12.

The power switching device 18 may be implemented with any suitable apparatus such as an air-gap relay, solid state relay, etc. An air gap relay may be of the normally open, normally closed, latching type, etc. A solid state relay may be non-isolated, optically isolated, magnetically isolated, etc.

The communication interface 20 may be implemented with any suitable apparatus including dedicated control conductors to energize an air-gap relay coil or control the gate of a solid state relay, dedicated communication conductors to transfer metering data to a control module such as RS-232, RS-485, etc. The control and communication functions may also be combined in a control network and protocol such as Modbus, Lonworks, control area network (CAN), etc.

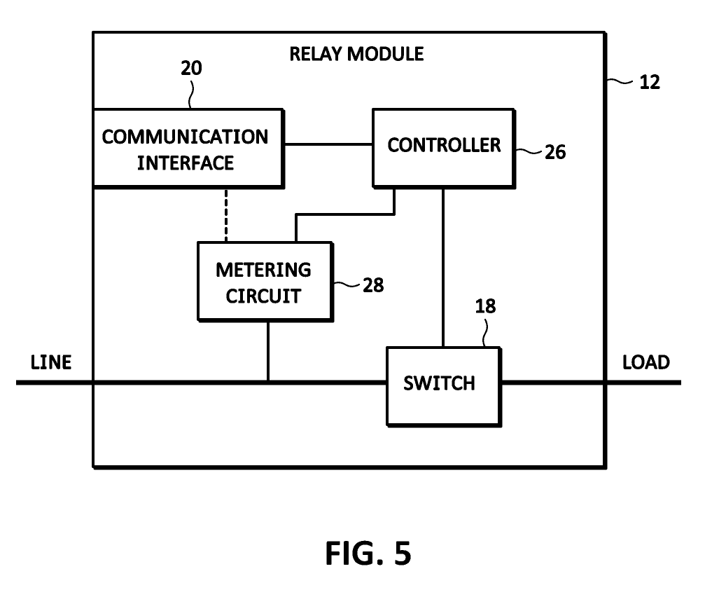

FIG. 5 illustrates an exemplary embodiment of a relay module having revenue-grade metering according to some inventive principles of this patent disclosure. The module 12 of FIG. 5 includes a power switch 18 and communication interface 20 similar to those shown in FIG. 4. The embodiment of FIG. 5, however, includes a controller 26 and metering circuit 28 that are used to implement the revenue-grade metering, control and communication functions. These functions may be distributed between the controller 26 and metering circuit 28 in any suitable manner. For example, in some embodiments, the metering circuit 28 may be a complete, self-contained metering solution that includes current and voltage sensing circuitry, as well as a dedicated integrated circuit (IC) that includes the processing power to perform revenue-grade metering calculations. In other embodiments, the metering circuit 28 may only include current and voltage sensing circuitry, while the controller 28 includes an analog-to-digital converter (A/D converter or ADC) and a microcontroller or microprocessor that includes the processing power to perform the revenue-grade metering calculations. Alternatively, the processing power may be distributed between the controller 26 and metering circuit 28 in any suitable manner.

As in the embodiments of FIGS. 3 and 4, the relay module of FIG. 5, as well as any of the relay modules in this patent disclosure, may also include circuitry to provide control outputs in response to commands received through the communication interface such as a 0-10 volt dimming control output, Digital Addressable Lighting Interface (DALI) output, etc. In other embodiments, any other suitable combination of power and/or control connections may be included.

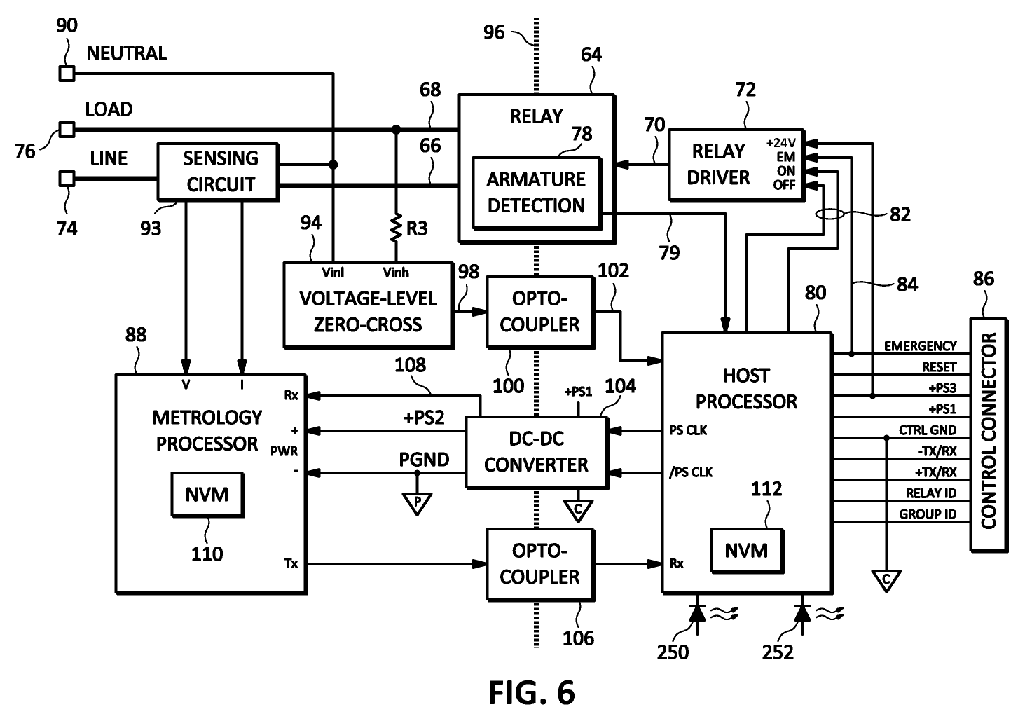

FIG. 6 illustrates an exemplary embodiment of a relay module according to some inventive principles of this patent disclosure. The embodiment of FIG. 6 illustrates some possible implementation details, but the inventive principles are not limited to these details. Referring to FIG. 6, an air-gap relay 64 switches power between a line conductor 66 and a load conductor 68 in response to relay drive signals 70 from a relay driver 72. The line and load conductors can be connected to building wiring at a relay panel through screw terminals 74 and 76. The relay 64 includes armature detection apparatus 78 that generates armature signals 79 to enable a host processor 80 to determine the position of the relay armature. The relay driver 72 typically generates the relay drive signals 70 in response to relay control signals 82 from the host processor 80. During emergency or override conditions, however, the relay driver 72 may turn the relay 64 on or off in response to one or more emergency signals 84 received through a control connector 86 on the relay module.

A neutral terminal 90 provides access to the neutral conductor for the branch circuit served by the relay 64 and may be implemented in any suitable manner such as a screw terminal, a plug-in connector on the relay housing, etc.

A metrology processor 88 is interfaced to the line conductor 66, the load conductor 68, and the neutral terminal 90 through a sensing circuit 93 that enables the analog front end of the metrology processor 88 to measure the voltage and current which are used to calculate the values of metrology parameters. The sensing circuit 93 may include any suitable voltage and current sensing apparatus including resistive voltage dividers, voltage and/or current transformers, Hall effect sensors, shunt resistors, etc., some examples of which are described below.

The actual calculations may be performed at the metrology processor, at the host processor, or they may be distributed between the processors. As a first example, the metrology processor may only perform synchronized A/D conversion of voltage and current, then periodically transmit the measured values to the host processor which performs all of the calculations.

As a second example, the metrology processor may measure and transmit the voltage and current as in the first example, but additionally, the metrology processor may also perform one or more fundamental calculations such as multiplying pairs of voltage and current measurements to calculate instantaneous power, then transmit the calculated power value to the host processor for further calculation of average power, watt-hours, etc.

As a third example, the metrology processor may include a fully self-contained compute engine that uses the voltage and current measurements to calculate the values of numerous metrology parameters such as line frequency, RMS voltage and current, active and reactive power, etc. Any or all of these computed values may then be transmitted to the host processor 80.

Some examples of suitable metrology processors include the Teridian (Maxim) MAXQ3183, the MAXQ3103, the TI MSP430AFExxx, the Microchip MCP3903, and the NXP EM773.

Non-volatile memories 110 and 112 are shown in the metrology processor 88 and the host processor 80, respectively. These memories may be used for long-term storage of calibration constants and/or metrology data accumulators. The memories may be internal and/or external to the processors, and may be distributed between the processors in any suitable manner.

The circuitry in the relay module is divided between a high voltage side and a low voltage side. An isolation boundary 96 separates circuitry connected to the high voltage components from circuitry connected to the low voltage control connector 86. Power and information flow between the two sides through magnetic and optical coupling which provide a suitable level of isolation between the sides. For example, magnetic and optical coupling components rated for 7 KV may be used in a system intended to comply with the IEEE C62-41 Cat B3/C1 standard (6 KV @ 3KA surge rating) for indoor-outdoor use.

A voltage-level zero-cross detection circuit 94 has a low input Vinl referenced to the neutral terminal 90 and a high input Vinh that monitors the voltage at the load terminal 68 through a voltage dropping resistor R3. A zero-cross signal 98 from the zero-cross detection circuit 94 is coupled to the host processor 80 through an opto-coupler circuit 100 which transmits an isolated version of the signal 102 to the host processor.

Power to operate the metrology processor 88 and other circuitry on the high voltage side is provided by a magnetically coupled DC-DC converter 104 which receives input power through connections to the positive power supply (+PS1), e.g., +5 volts, and control ground (“C” ground) from the control connector 86. Power switches in the DC-DC converter 104 are driven by power supply clock signals PS CLK and /PS CLK generated by the host processor 80. The output from the DC-DC converter 104 is a regulated power supply (+PS2), e.g., +3.3 volts, referenced to the line conductor 66 (“P” ground).

Communication from the metrology processor 88 to the host processor 80 is facilitated by another opto-coupler circuit 106 which couples the Tx communication output of the metrology processor 88 to the Rx communication input of the host processor 80.

Another opto-coupler circuit could be used for communication in the other direction from the host processor 80 to the metrology processor 88. However, to eliminate the need for another isolation component, the serial communication output of the host processor 80 is modulated onto the power supply clock signals PS CLK and /PS CLK and recovered in the output side of the DC-DC converter 104 as described in more detail below. The recovered output signal 108 is then applied to the Rx communication input of the metrology processor 88.

As mentioned above, the control connector 86 provides the positive power supply (+PS1) and control ground (“C” ground) connections for the low-voltage side of the circuitry in the relay module, as well as an emergency/override signal 84 that can operate the relay driver and is also applied to the host processor 80. Additionally, the control connector includes connections to the host processor 80 for the following signals: a reset signal RESET to reset the host processor; a second power supply (+PS3), e.g., +24 volts, which also provides operating power to the relay driver 72; two serial communication lines −TX/RX and +TX/RX which provide bi-directional communication between the relay module and a control module on the relay panel; and two analog signals RELAY ID and GROUP ID which enable the control module to identify the relay module and any group it may belong to.

Other apparatus that are not illustrated but may be included are: a hardware communication interface such as RS-485/Modbus for the −TX/RX and +TX/RX serial communication lines; ESD protection circuitry; and power-fail sensing circuitry.

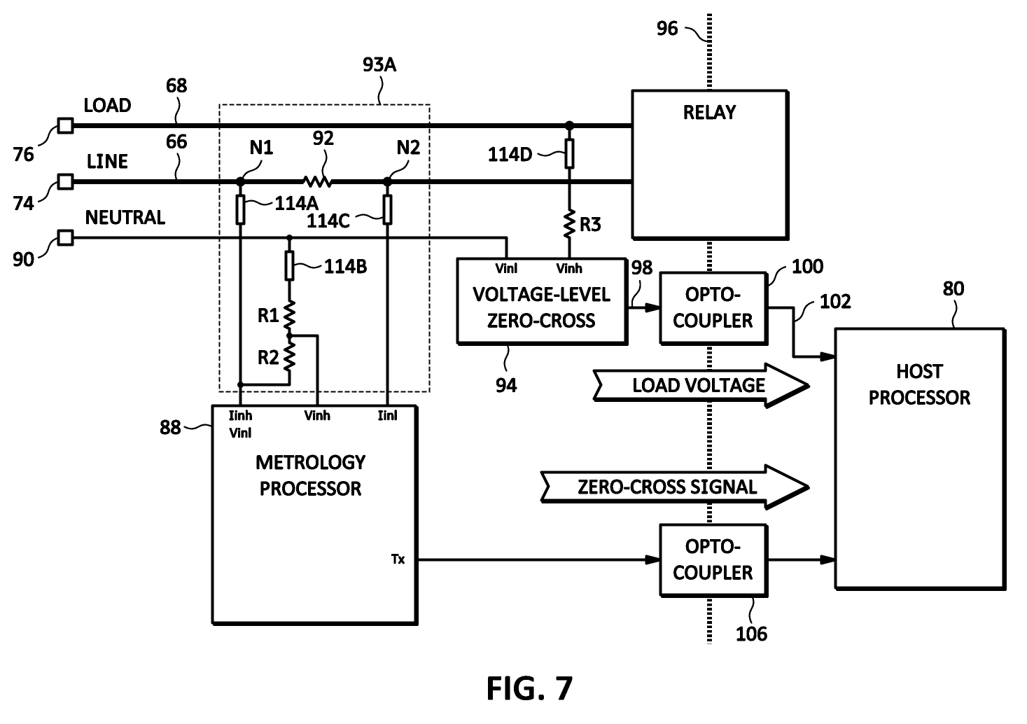

FIG. 7 illustrates an exemplary embodiment of a sensing circuit 93A according to some inventive principles of this patent disclosure. The embodiment of FIG. 7 may be used, for example, as the sensing circuit 93 of FIG. 6, and thus, is shown in the context of some of the associated circuitry of the relay module.

Referring to FIG. 7, the analog front end of the metrology processor 88 is referenced to the line conductor 66. The sensing circuit 93A includes a resistive current shunt 92 in series with the line conductor 66 to enable the metrology processor to measure current through the line conductor 66.

The metrology processor 88 measures the voltage through a resistive voltage divider R1 and R2. The low end of the divider is referenced to the line conductor at node N1, while the high end of the divider is connected to a neutral terminal 90. The low side Vinl of the analog voltage input on the metrology processor 88 is connected to the line conductor, while the high side Vinh of the analog voltage input on the metrology processor is connected to the divider node between R1 and R2.

The metrology processor 88 measures current through a resistive current shunt 92 in series with the line conductor. The high side Iinh of the analog current input on the metrology processor is connected to the line conductor at one end of the current shunt at node N1, while the low side Iinl of the analog current input on the metrology processor is connected to the line conductor on the other side of the current shunt at node N1. The resistive shunt 92 may be implemented with a dedicated resistive material having a small temperature coefficient to provide accurate measurement over the entire operating temperature range.

Alternatively, the shunt may be implemented as a section of a bus bar between the relay 96 and line terminal 74 with Kelvin connections welded or brazed to the bus bar. Using a section of bus bar as a shunt may provide a significant cost benefit. The accuracy of a bus bar shunt may be improved by determining its temperature coefficient, then adjusting the current measurements accordingly based on the amount of current flowing through the shunt and/or its temperature.

The configuration of the metrology processor 88 and zero-cross detection circuit 94 as illustrated in FIGS. 6 and 7 may provide several benefits and advantages. The components may be laid out on a circuit board in a manner that enables a manufacturer to provide different versions of the relay module using the same circuit board. For example, in a version that includes the metrology processor 88, the metrology processor can be used to provide a zero-cross signal to the host processor through opto-coupler circuit 106 because the metrology processor monitors the voltage of the line conductor 66. This frees up the voltage-level zero-cross detection circuit 94 to be connected to the load side of the relay, which enables the host processor to monitor the load voltage to determine if contact welding or other damage has occurred, if the relay is mis-wired, etc.

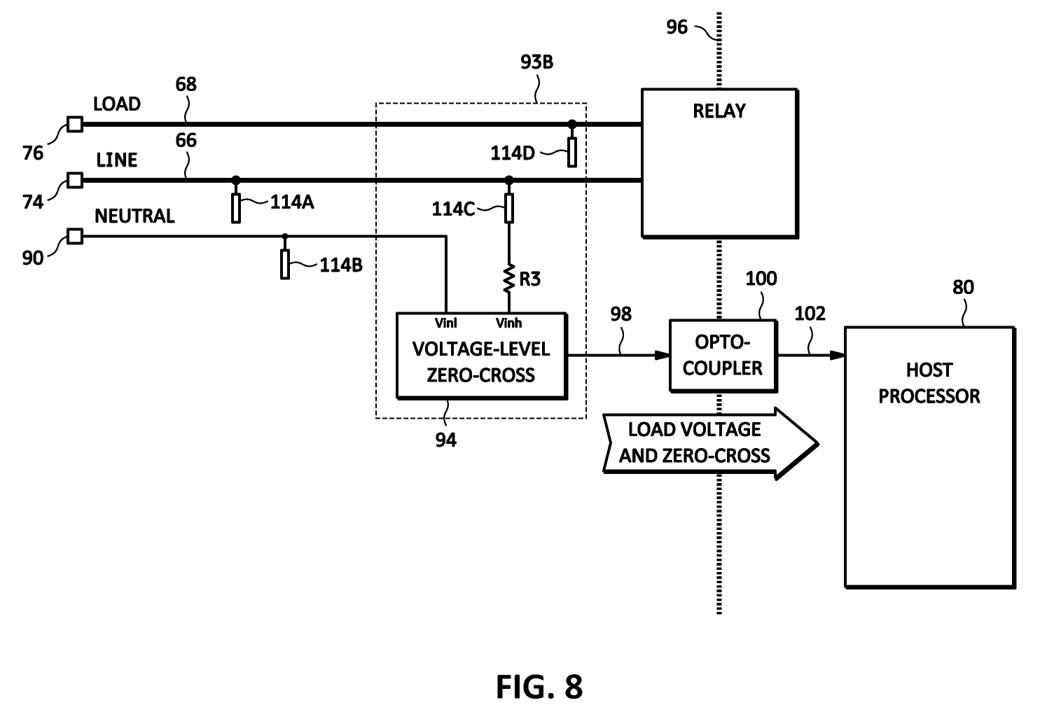

In another version without metering capabilities, however, the metrology processor may be omitted to provide a lower cost relay module as shown in FIG. 8, which illustrates another exemplary embodiment of a sensing circuit 93B according to some inventive principles of this patent disclosure. The embodiment of FIG. 8 illustrates how the sensing circuit 93A of FIG. 7 may be reconfigured to provide a version of a relay module without metrology.

In this version, the voltage-level zero-cross detection circuit 94 may be configured to monitor the line voltage rather than the load voltage and provide a zero-cross detection signal 98 to the host processor 80 through opto-coupler circuit 100. The voltage-level zero-cross detection circuit 94 may also provide a measure of the line voltage to an A/D converter input on the host processor. When configured in this version, the low input Vinl of the zero-cross detection circuit 94 may be reference to the neutral terminal 90, while the high input Vinh may be connected to the line conductor 66 as shown in FIG. 8. Alternatively, the low input Vinl may be referenced to line conductor 66 while the high input Vinh is connected to the neutral terminal 90.

To facilitate reconfiguration of the metrology processor 88 and zero-cross detection circuit 94 for different versions of the relay module, some or all of the connections to the line conductor 66, load conductor 68 and/or neutral terminal 90 may be made through connectors or configurable conductors 114A-114D as shown in FIGS. 7 and 8. For example, the connections for the voltage and current sensing for the metrology processor 88 and the zero-cross detection circuit 94 may be made through “flying leads,” that is, wire leads that loop between selectable contact locations on a circuit board and are then soldered in place to form the desired circuit configuration.

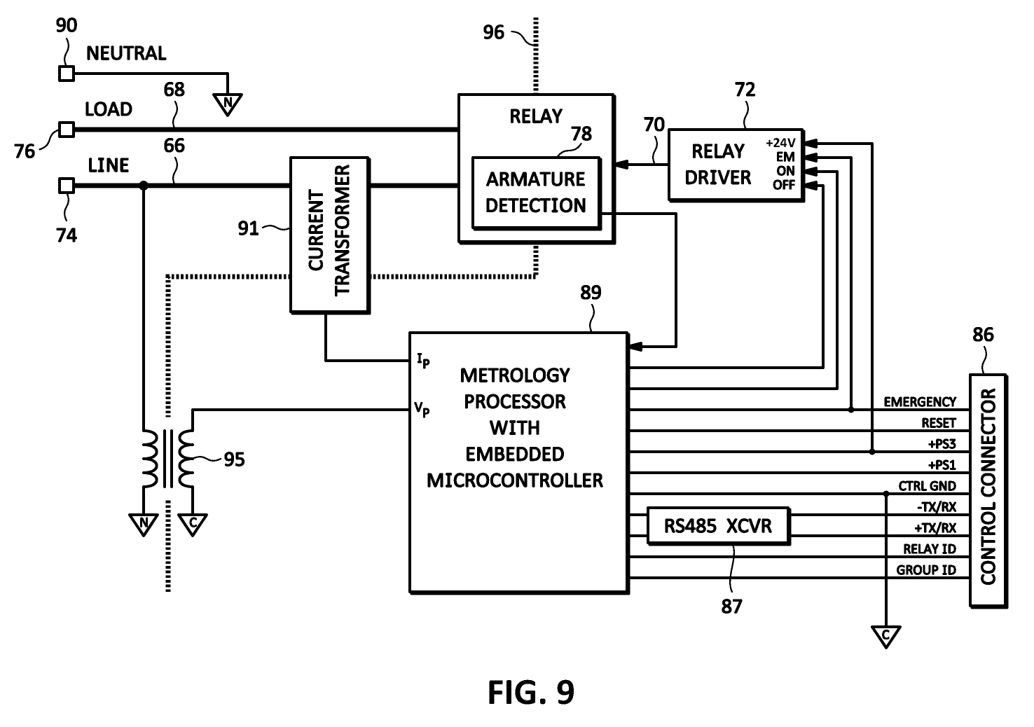

FIG. 9 illustrates another embodiment of a relay module having a metrology processor according to some inventive principles of this patent disclosure. In the embodiment of FIG. 9, the host processor is eliminated and replaced with a microcontroller that is embedded in a metrology processor 89. Voltage sensing is provided by a voltage sense transformer 95, while current sensing is provided by a current transformer 91. Thus, the metrology processor may be referenced to the control ground and isolated from the high-voltage circuitry by the voltage sense transformer 95 and the current transformer 91. The voltage sense transformer 95 is referenced to the line conductor 66. The control bus transceiver 87, which is omitted from figures of other embodiments, is illustrated in FIG. 9.

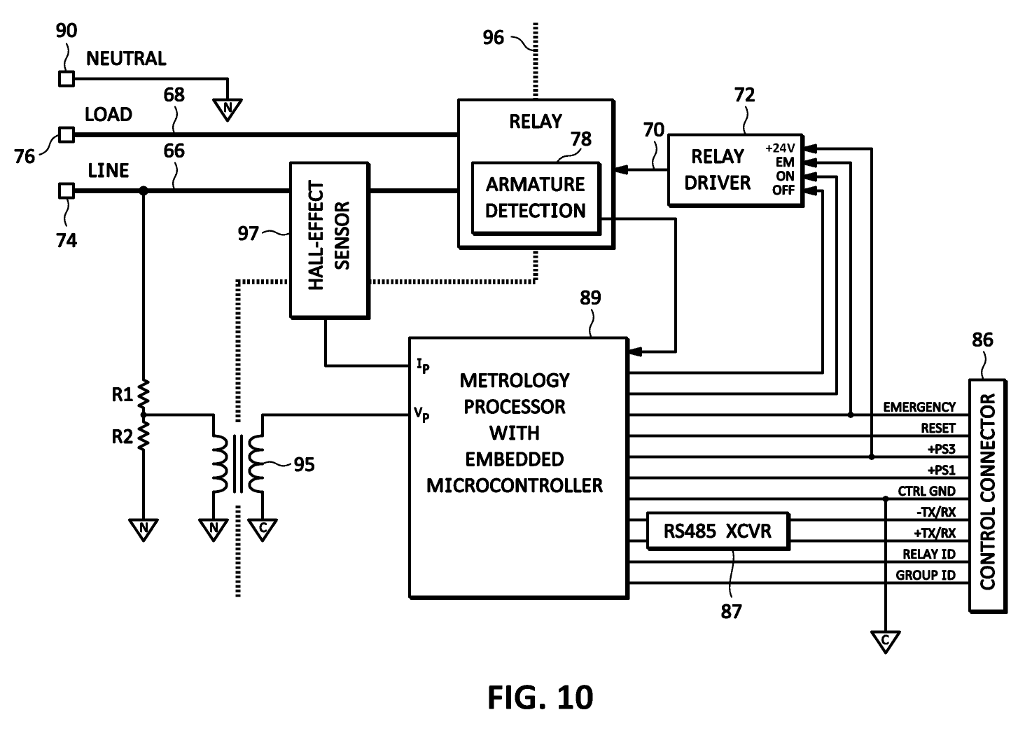

FIG. 10 illustrates another embodiment of a relay module having a metrology processor according to some inventive principles of this patent disclosure. The embodiment of FIG. 10 is similar to that of FIG. 9, but a resistive voltage divider R1 and R2 is arranged upstream of the voltage sense transformer 95 so a lower voltage transformer may be utilized, thereby reducing its size. Also, the current transformer is replaced with a Hall-effect sensor 97.

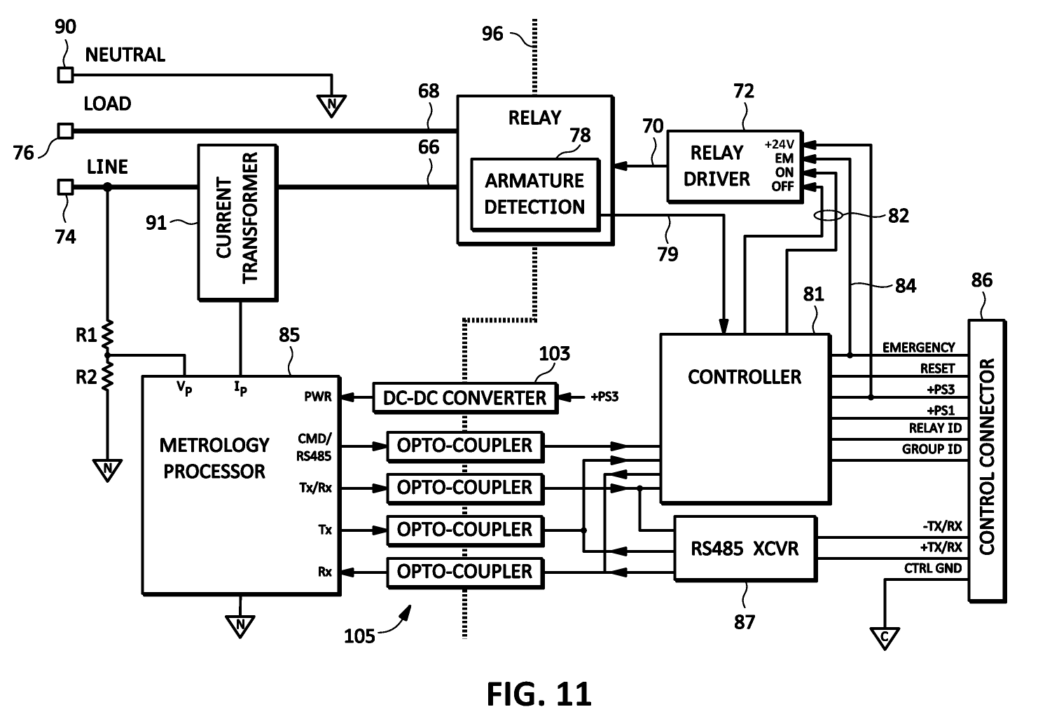

FIG. 11 illustrates another embodiment of a relay module having a metrology processor according to some inventive principles of this patent disclosure. In the embodiment of FIG. 11, a metrology processor 85 having half-duplex communications is used in conjunction with a microcontroller 81 and a bank of opto-couplers 105. A DC-DC converter 103 provides power to the metrology processor 85 which is referenced to the neutral terminal 90. Thus, no isolation is required for the voltage sensing, which is accomplished through a resistive divider R1 and R2. Current is sensed through a current transformer 91.

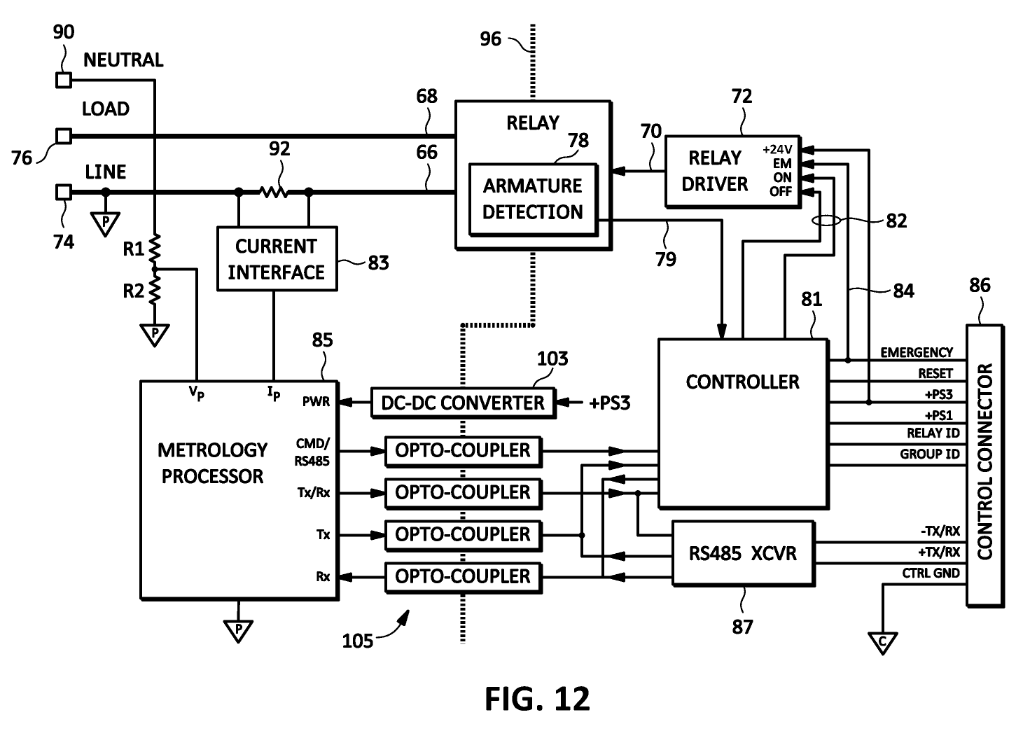

FIG. 12 illustrates another embodiment of a relay module having a metrology processor according to some inventive principles of this patent disclosure. The embodiment of FIG. 12 is similar to that of FIG. 11, but the metrology processor 85 is now references to the line conductor 66 (“P” ground), and the high end of the voltage divider R1 and R2 is connected to the neutral terminal 90. Current sensing is provided by a resistive shunt 92 in series in the line conductor 66. A current interface 83 may include analog circuitry to convert the signal from the current shunt 92 to a form usable by the metrology processor 85.

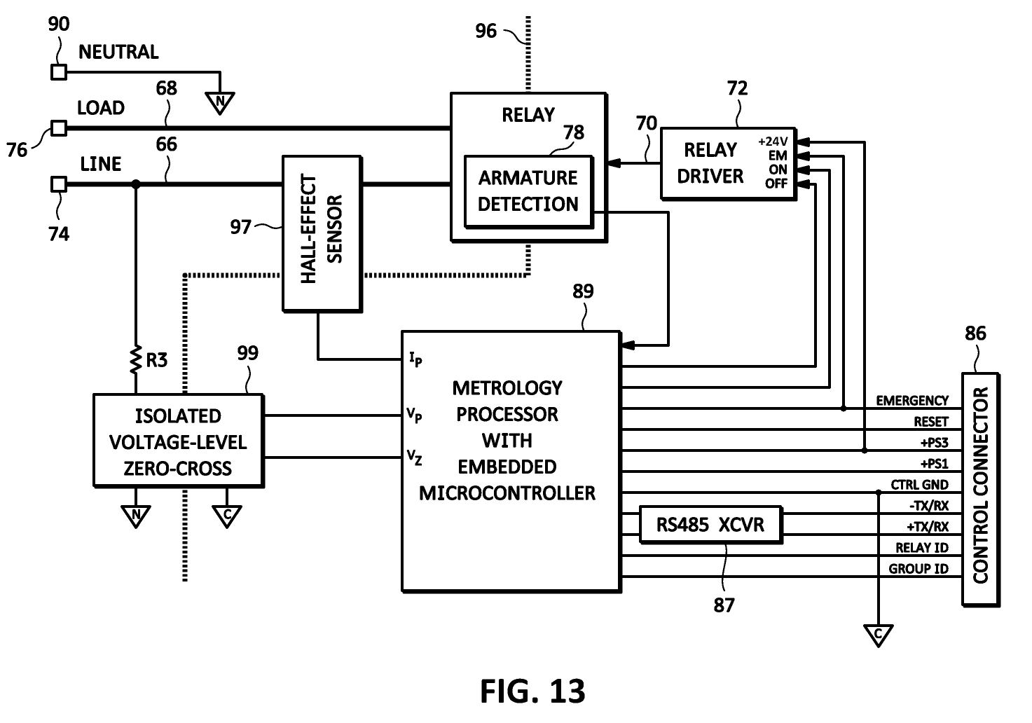

FIG. 13 illustrates another embodiment of a relay module having a metrology processor according to some inventive principles of this patent disclosure. The embodiment of FIG. 13 includes a metrology processor 89 having an integrated microcontroller and Hall-effect current sensor as in the embodiment of FIG. 10. However, in the embodiment of FIG. 13, an isolated voltage-level zero-cross detection circuit 99 provides the metrology processor 89 with a measure of the line voltage V_{P} as well as a zero-crossing detection signal V_{Z}. The metrology processor 89 and the low-voltage side of the isolated voltage-level zero-cross detection circuit 99 are referenced to the control circuit ground (“C” ground), while the high-voltage side of the zero-cross detection circuit 99 is referenced to the neutral terminal 90.

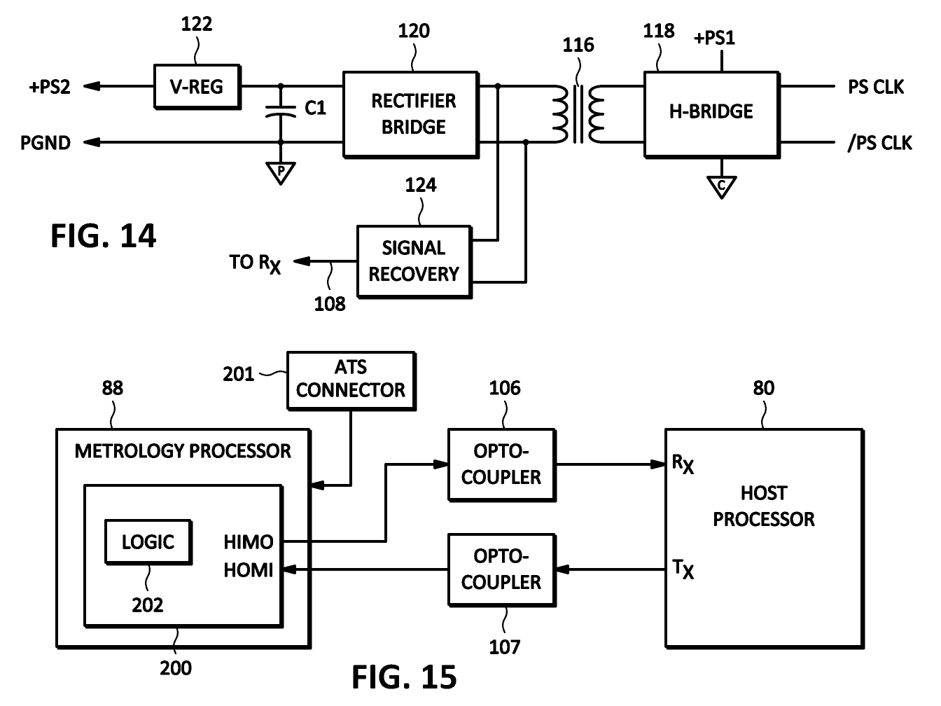

FIG. 14 illustrates an embodiment of a DC-DC converter having a communication signal modulated onto the switching signal according to some inventive principles of this patent disclosure. The primary side of transformer 116 is driven by a primary switching power signal generated by power transistors in an H-bridge 118 in response to the power supply clock signals PS_CLK and /PS_CLK on which a communication signal is modulated.

The secondary switching power signal from the secondary side of transformer 116 is applied to a full-wave bridge rectifier 120, then filtered by a filter capacitor C1 and regulated by a voltage regulator 122 to provide the regulated power supply +PS2 which is referenced to the line conductor (“P” ground). A signal recovery circuit 124 demodulates the communication signal 108 from the secondary switching power signal. The recovered communication signal 108 can then be applied as the Rx input of a metrology processor, or used for any other suitable purpose.

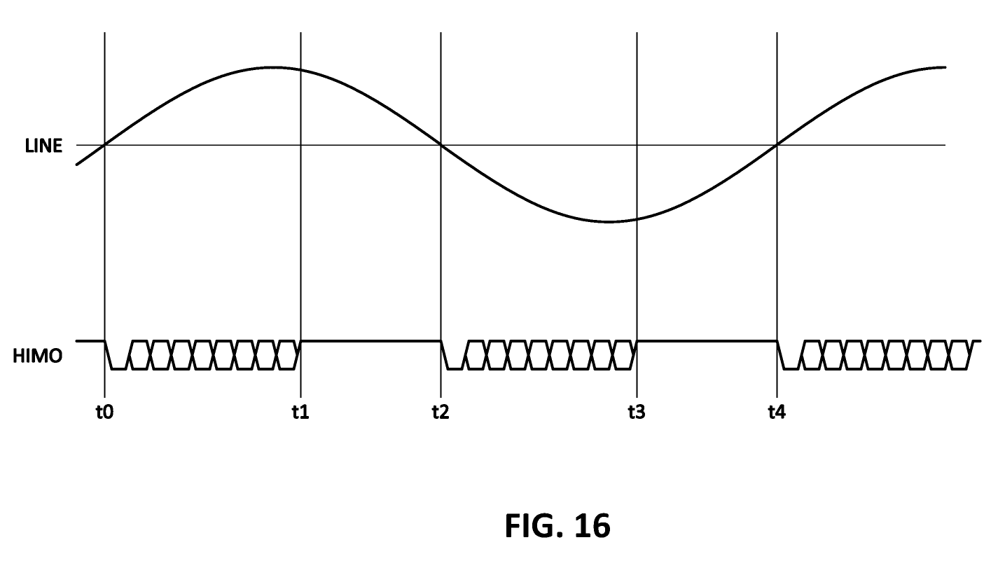

FIG. 15 illustrates an embodiment of a communication port configuration that uses the start bit of a communication packet to signal a zero crossing according to some inventive principles of this patent disclosure. FIG. 16 illustrates an embodiment of a timing sequence for using the start bit of a communication packet to signal a zero crossing according to some inventive principles of this patent disclosure.

In the embodiment of FIG. 15, a host processor 80 has a serial input Rx and a serial output Tx that communicates with a serial interface port 200 on a metrology processor 88 through opto-coupler circuits 106 and 107. The port 200 on the metrology processor 88 includes logic 202 that has been adapted to implement the inventive principles. The host in master out (HIMO) and host out master in (HOMI) lines on the port 200 on the metrology processor 88 are connected to the Rx and Tx lines of the host processor 80, respectively.

A connector 201 provides a port for an automated test system (ATS) to program the metrology processor and nonvolatile memory.

The logic 202 in the port 200 initiates an asynchronous data transmission each time the metrology processor detects a zero cross as shown at times t0, t2, and t4 as shown in FIG. 16. Each transmission includes a low-true start bit followed by a data payload having any suitable number of bits, e.g., 8 bits. The zero-cross detection may always be based on a voltage zero-cross or it may sometimes be based on a voltage zero-cross and sometimes based on a current zero-cross as explained in more detail below.

An advantage of using the start bit of a communication packet to signal a zero crossing is that it eliminates an entire zero-cross detection circuit with its associated cost and space requirements.

In a relay module, the host processor or other controller may utilize zero-crossing information to synchronize the opening and/or closing of relay contacts with a zero-crossing in the voltage waveform to extend the useful life of the contacts. If the contacts open when the line voltage is relatively high, inductance in the circuit tends to cause an arc to form across the opening contacts, thereby causing pitting of the contacts and possible oxidation that forms a barrier to conduction through contacts. Likewise, if the contacts close when the line voltage is relatively high, contact bounce also produces multiple opportunities for damaging arcs to form across the contacts and possibly weld the contacts together. Thus, opening and/or closing the relay contacts at or near a zero-crossing in the voltage waveform tends to reduce arcing and extend contact life.

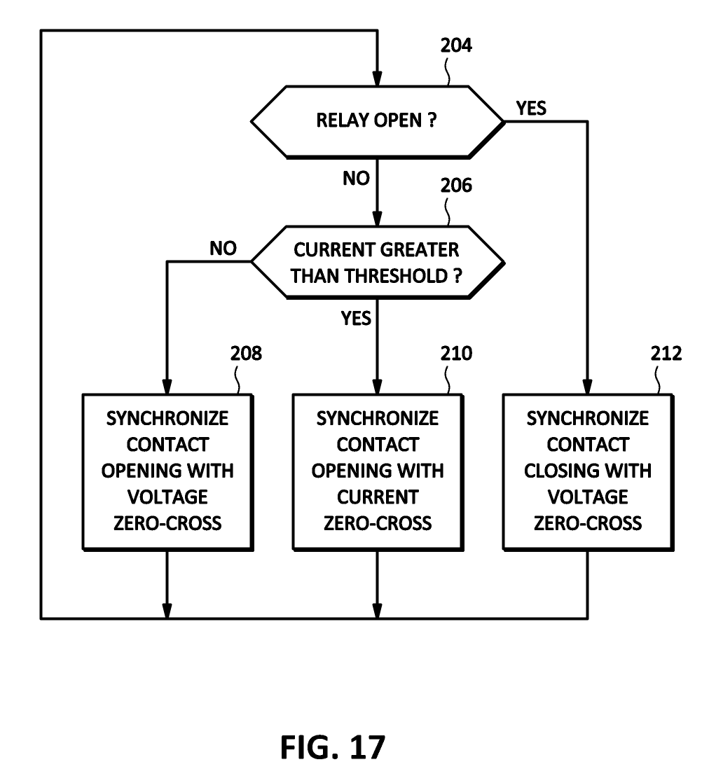

FIG. 17 illustrates an example embodiment of a method for selectively synchronizing the opening of relay contacts in response to a different type of zero-crossing depending on the load conditions according to some inventive principles of this patent disclosure. This method may be implemented in a metrology processor, a host processor, distributed between the two processors, or in any other hardware, software, firmware, etc., or any suitable combination thereof.

Beginning at 204, if the relay is open, there is no current flowing, so the method proceeds to 212 and synchronizes the next closing of the relay contacts with a voltage zero-crossing. If the relay is closed, the amount of current flowing through the relay contacts is determined through any suitable manner. At 206, if the current is greater than a suitable threshold, for example, one amp, then the next opening of the relay contacts is synchronized with a zero crossing in the current at 210. If the current is less than the threshold at 206, then the next opening of the relay contacts is synchronized with a zero-crossing in the voltage at 208.

An advantage of the method illustrated in FIG. 17 is that it extends the useful life of the relay contact to a greater extent than relying on voltage zero-crossings alone. When a relatively large amount of current is flowing through the relay contacts, opening the contacts at a voltage zero-crossing may not necessarily reduce arcing adequately because, due to phase differences between the voltage and current waveforms, there may still be significant current flowing through the relay contacts even at the point of a voltage zero-crossing. Synchronizing the opening of the relay contacts with a current zero-crossing when significant current is flowing through the relay contacts may reduce and/or eliminate arcing to a greater extent than relying on voltage zero-crossing alone. This may be because arcing tends to be caused by inductance which causes arcing in response to current flow, rather than voltage.

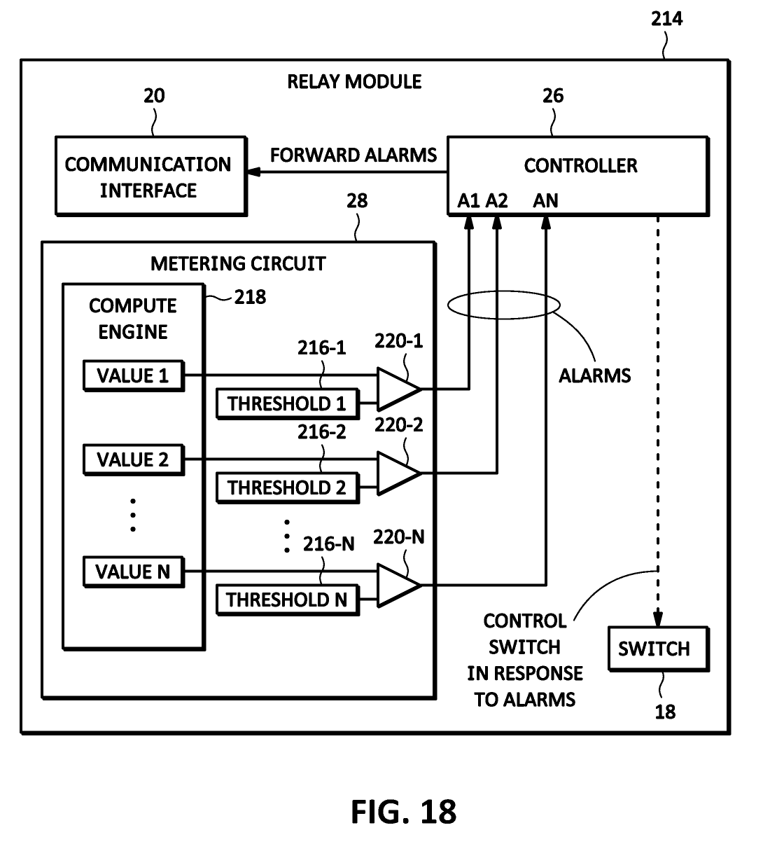

FIG. 18 illustrates an embodiment of a relay module having programmable thresholds for alarms according to some inventive principles of this patent disclosure. The embodiment of FIG. 18 is similar to the embodiment of FIG. 5 with the addition of elements for implementing programmable alarm thresholds. However, only the connections, actions and elements relevant to programmable alarm thresholds are shown to highlight the additional inventive principles illustrated in FIG. 18.

Threshold values may be downloaded from a control module at the relay panel on which the relay module 214 is mounted. The threshold values may be stored at the controller 26 (including any associated external memory) or metering circuit 28 (including any associated external memory). In this embodiment, the threshold values are stored in threshold storage elements 216-1 through 216-N at the metering circuit 28, which also includes a compute engine 218 that calculates the values of various parameters such as RMS voltage, RMS current, various types of power, etc., based on the current and voltage measurements. Comparator elements 220-1 through 220-N continuously or periodically compare the calculated parameters to the stored threshold values and generate alarms A1, A2 . . . AN when a parameter reaches the corresponding threshold.

The controller 26 then forwards the alarms to a control module at the relay panel through communication interface 20. Additionally or alternatively, the controller 26 may control the switch 18, e.g., open the switch, in response to an alarm.

Logic in the controller 26 or metering circuit 28 may implement any suitable alarm actuation scheme. For example, an alarm may be generated immediately when a parameter reaches a threshold, or only after it has exceeded the threshold for a predetermined length of time. As another example, certain alarms may be actuated only after different combinations of parameters reach different thresholds.

The comparison elements 220-1 through 220-N, the threshold storage elements 216-1 through 216-N, the compute engine 218, and any of the associated logic may be implemented in analog or digital hardware, software, firmware, or any suitable combination. Examples of alarm thresholds include, but are not limited to, the following: high line voltage, low line voltage, high line current, low line current, high true power (KW), high apparent power (KVA), high reactive power (KVAR), high total harmonic distortion (THD), and low power factor (PF).

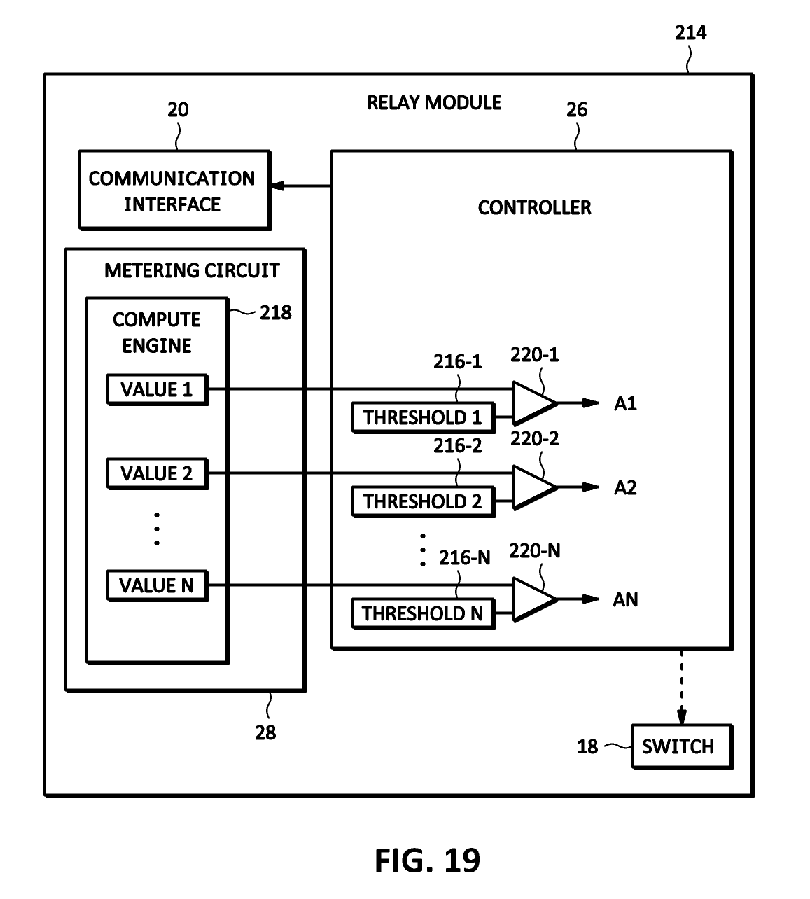

FIG. 19 illustrates another embodiment of a relay module having programmable thresholds for alarms according to some inventive principles of this patent disclosure. In the embodiment of FIG. 19, the threshold storage elements 216-1 through 216-N and comparator elements 220-1 through 220-N are located in the controller 26, while the compute engine 218 remains in the metering circuit 28. In other embodiments, the compute engine 218 may also be moved to the controller 26. In yet other embodiments, all of the alarm threshold functionality may be combined in a single processor that is integrated with, or separate from, the metering circuit 28 and or the controller 26.

In still other embodiments, the relay module does not actually generate an alarm, but instead, merely reports to the control module that a threshold has been exceeded. The control module may than make a decision as to whether an alarm should be generated. In a hybrid embodiment, the relay module may report an alarm to the control module, but then wait for the control module to make a decision as to what action, if any, the relay module should take in response to the alarm.

In the embodiments of FIGS. 18 and 19, the threshold storage elements through and comparator elements are located in the relay modules. In other embodiments, however, the threshold storage and comparator elements may be located in the control module. The relay modules may then transmit meter data to the control module where the meter data is compared to thresholds to generate alarms.

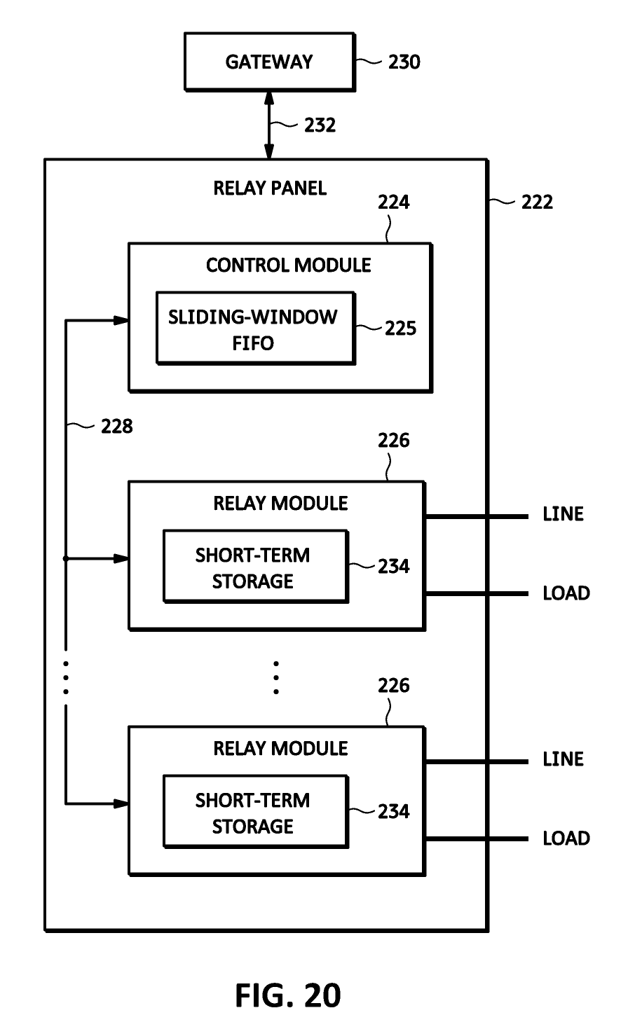

FIG. 20 illustrates an embodiment of a relay panel system having metering data storage according to some inventive principles of this patent disclosure. The embodiment of FIG. 20 includes a relay panel 222 having a control module 224 and multiple relay modules 226. The relay modules 226 are interfaced to the control module 224 through a control bus 228. The control module 224 communicates with a gateway 230 through a communication network 232.

One or more of the relay modules 226 may include metering circuitry that enables it to measure the relay voltage and current and use these measurements to calculate various metering parameters. These metering relay modules may include short-term storage 234 for storing metering data generated by the metering calculations. The metering relay modules may store metering data in the short-term storage 234 for any suitable time period.

For example, in one embodiment, the metering relay modules 226 may calculate and store the following data for long enough to enable the relay module to transmit the data to the control module once every second: line voltage (RMS) line current (RMS), real power (Watts), reactive power (VARs), apparent power (VAs), power factor (PF), accumulated real energy (KW Hours), accumulated apparent energy (KVA Hours), accumulated reactive energy (KVAR Hours), line frequency (Hz), harmonic distortion line voltage (percent), and harmonic distortion line current (percent).

In other embodiments, the metering relay modules 226 may store up to 15 minutes worth of data between transfers to the control module 224. The amount of time for which the metering data can be stored may depend on how many parameters are stored. Thus, if the metering relay modules only store data for three different parameters, the time period for which they can store data may be longer than if data for all twelve of the parameters listed above is stored.

The metering relay modules 226 may initiate transmissions periodically, e.g., at specified intervals or when it accumulates a certain amount of data. Alternatively, the metering relay modules 226 may operate in a polled mode in which they only transmit metering data when polled by the control module.

The control module 224 includes storage 225 that can store metering data it receives from the metering relay modules 226. The control module retransmits the metering data to a gateway 230 where it is collected and aggregated or forwarded to another data aggregation location.

The storage 225 at the control module 224 may be implemented as a first-in first-out (FIFO) memory having any suitable size. For example, the FIFO may be implemented as a sliding window FIFO having a 24-hour window size.

Some accumulated parameters may be stored at the metering relay modules 226 and/or the control module 224. These accumulated parameters may be thought of as being analogous to “odometers” for the total amount of real, apparent and/or reactive energy that has flowed through a relay module. For example, in some embodiments, the accumulated total energy throughput of real energy (KWh), apparent energy (KVAh) and reactive energy (KVARh) may be updated every minute and stored at the relay modules. These accumulated total energy measurements may then be transmitted periodically to the control module and copied into nonvolatile memory on a regular basis in case any relay module needs to be replaced.

In an embodiment in which the metering relay modules 226 regularly transmit data to the control module 224, the storage 225 at the control module 224 may be implemented with multiple FIFOs that store overlapping data in a pattern that provides histories of progressively longer periods of time for analysis and control purposes. For example, in an implementation in which the metering relay modules 226 transmit metrology data to the control module 224 every second, the control module may include some or all of the following FIFOs:

Last-Minute Statistics FIFO: historic “stored metrology data” starts with this function. This FIFO sliding-window accumulator stores the last 60 seconds of data.

1-Minute Statistics FIFO: every full minute, this FIFO accumulator stores the prior “Last-Minute” data.

5-Minute Statistics FIFO: every five minutes, this FIFO accumulator stores the last five “1-Minute” data points into the control module non-volatile memory.

Last 15-Minutes Statistics FIFO: every fifteen minutes, this FIFO accumulator adds and stores the last three 5-Minute data points into the control module non-volatile memory.

Last 96 Entries of 15-Minutes Statistics FIFO: every fifteen minutes, this FIFO accumulator stores the last 96 entries of 15-Minute Statistics into the control module non-volatile memory. This is used to describe the previous full 24-hour period.

Last 1-Day Statistics FIFO: every calendar day, this FIFO accumulator stores the last accumulation of the previous 24-hour period statistics into the control module non-volatile memory.

Last 7-Days Statistics FIFO: every calendar day, this FIFO accumulator stores the last seven 1-Day statistics into the control module non-volatile memory.

Last 54 7-Days Statistics: every calendar week, this FIFO accumulator stores the last 54 7-day's statistics into the control module non-volatile memory.

The metrology data stored in any or all of these FIFOs at the control module may be transmitted periodically to the gateway 230 at any appropriate time interval, either at the initiative of the control module, or when polled by the gateway or a data aggregation location that is networked to the gateway. Alternatively, the data collected by the control module every second may be forwarded to or through the gateway where similar FIFO memories may be implemented.

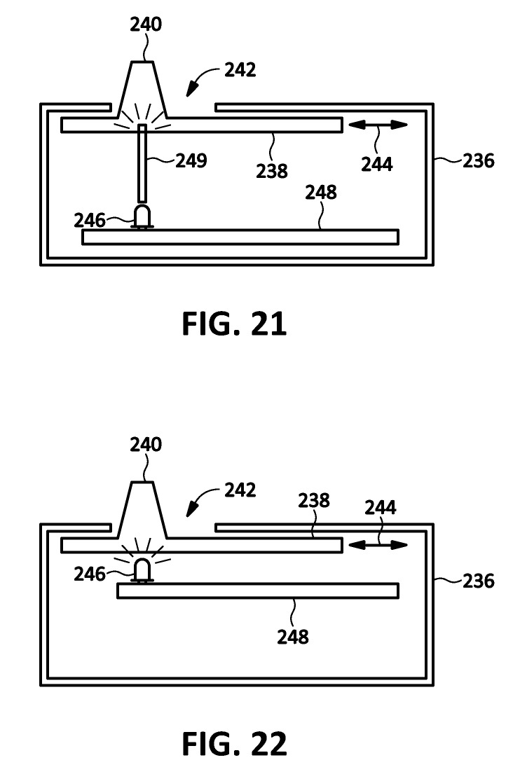

FIG. 21 illustrates an embodiment of a relay module having an illuminated actuator according to some of the inventive principles of this patent disclosure. The embodiment of FIG. 21 includes a housing 236 in which the internal components of the relay module are mounted. An actuator 238 includes a handle 240 that protrudes through an opening 242 in the housing 236 which enables a user to slide the actuator in the direction of arrow 244 to manually actuate a relay and/or any other suitable control functions. One or more light sources 246 are mounted to a circuit board 248 on which control circuitry for the relay module is fabricated. The LEDs may be controlled by one or more processors or controllers on the circuit board. For example, referring to FIG. 6, LEDs 250 and 252 may be controlled directly by a host processor 80. Light from the LEDs is coupled to the actuator handle 240 through one or more flexible light pipes 249 which are positioned in a manner that light from the light source is visible to a user. For example, the actuator may be molded from a clear plastic material.

Although the actuator 238 is illustrated as having a sliding motion in FIG. 21, the actuator may be implemented with any other suitable motion such as a rotating motion, toggle motion, etc.

The one or more light sources 246 may include any combination of light sources that may indicate to a user a status or condition at the relay. For example, a single LED may be illuminated constantly to indicate normal operation, but the LED may be flashed to indicate a fault condition. As another example, a single multi-color LED may be illuminated in a green mode to indicate normal operation, but illuminated in a red mode to indicate a fault condition. Blinking operation or additional colors may be added to specify the type of fault. As a further example, multiple LEDs may be included to provide additional combinations of colors and/or solid/blinking operation to indicate a wide variety of relay conditions or status.

Though not shown, the module includes other conventional features to enable it to function as a module, e.g., a mechanical interface to physically mount the module to a relay panel, a control connecter to connect the control electronics and/or other circuitry in the relay module to a control module through a control bus, power terminals to connect a power switching relay in the relay module to line and load conductors, and optionally a neutral terminal to provide access to the neutral conductor associated with the line and load conductors in the building wiring that is connected at the relay panel.

In an alternative embodiment, the light source 246 may be positioned in the actuator 238. For example, the light source may be one or more light-emitting diodes (LEDs) that are molded into the actuator, or attached to the actuator in any suitable manner. The LEDs are connected through flexible wire leads to a circuit board on which control circuitry for the relay module is fabricated.

FIG. 22 illustrates another embodiment of a relay module having an illuminated actuator according to some of the inventive principles of this patent disclosure. The embodiment of FIG. 22 is similar to that of FIG. 21, but the light source 246 is attached to the circuit board 248, which is positioned more closely to the actuator handle 240 to eliminate the need for wire leads or a light pipe while still guiding light to the actuator handle 240 in a manner that is visible to a user.

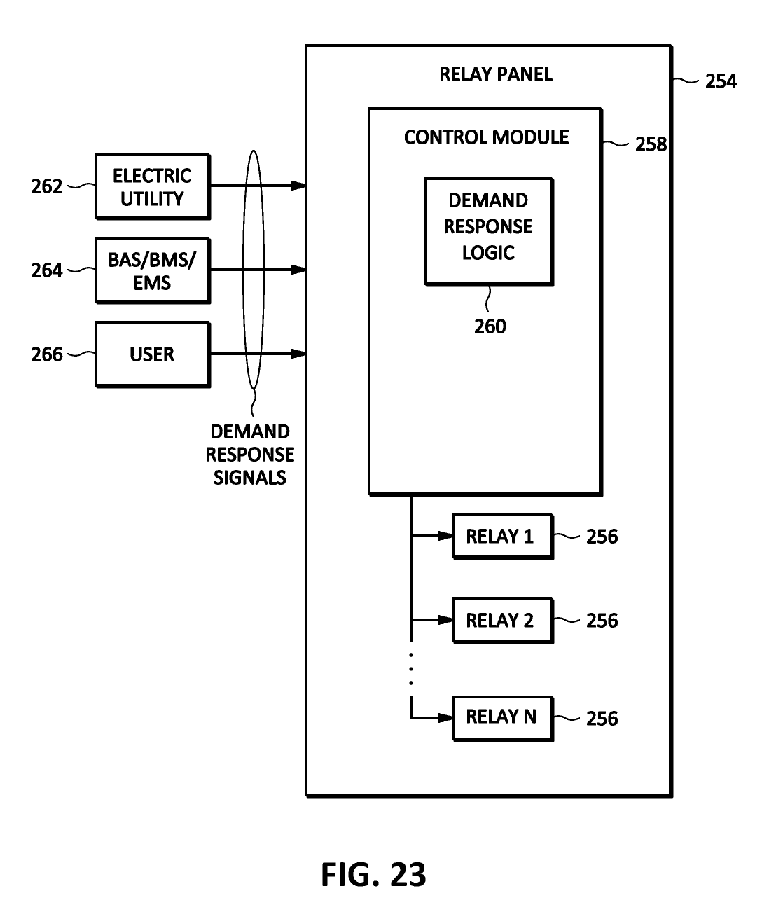

FIG. 23 illustrates an embodiment of a relay system having demand response capabilities according to some inventive principles of this patent disclosure. The system of FIG. 23 includes a relay panel 254, one or more relay modules 256 mounted to the relay panel, and a control module 258 mounted to the relay panel and configured to control the relay modules. The control module 258 includes logic 260 to decide how to control the one or more relay modules in response to a demand response signal received at the control module.

Example sources of demand response signals include an electric utility 262, a building automation system (BAS) 264 (sometimes referred to as a building management system (BMS) or an energy management system (EMS)), a manual input from a user 266, etc. A demand response signal from a utility 262 may be received automatically as a wired or wireless signal in a format such as the ZigBee Smart Energy wireless protocol. A utility may also send a demand response signal through a manual telephone call or an automated telephone calling system which may interface to the control module through a telephone modem.

A building automation system 264 may send a demand response signal through any appropriate physical network such as Ethernet, RS485, LonWorks, etc., using any suitable protocol such as TCP/IP, Modbus, BACnet, LonTalk, etc.

A manual input from a user may be received locally at the relay panel through a local keypad, touchscreen, pushbutton switch, etc., or remotely through a handheld display unit (HDU), personal computer, BAS workstation, etc., that is connected to the relay panel through any suitable network.

The demand response logic 260 may be implemented in analog and/or digital hardware, software, firmware, or any combination thereof. The demand response logic may implement any suitable decision-making system for responding to a demand response system, some examples of which are described below.

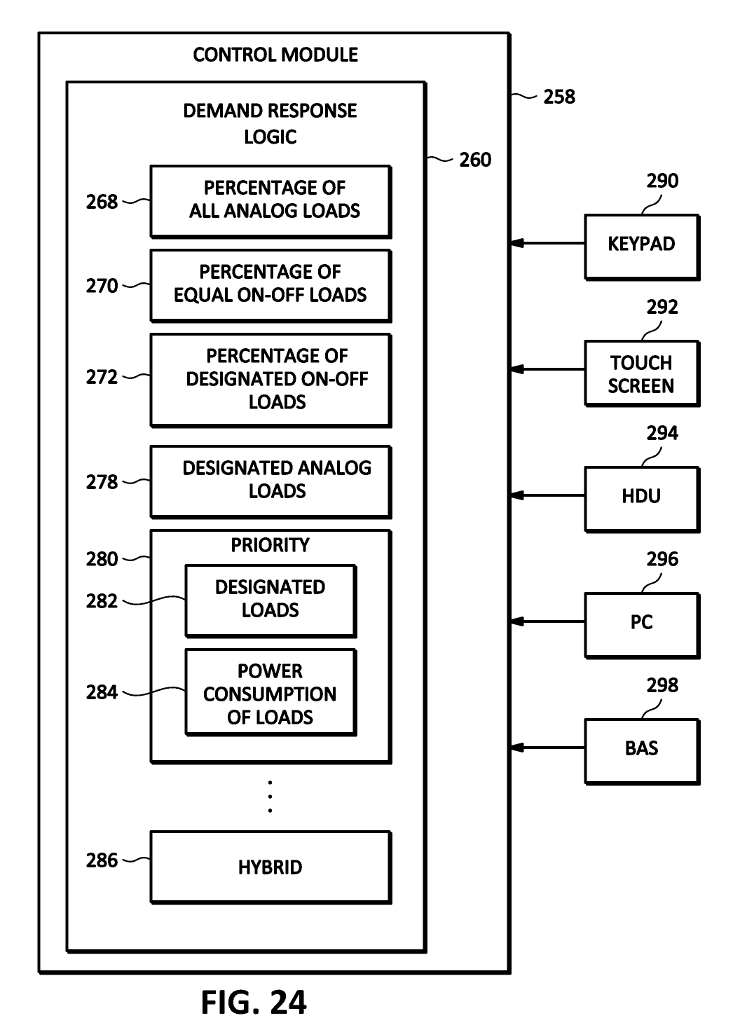

FIG. 24 illustrates an embodiment of a control module having demand response logic 260 with various load shedding logic to respond to a demand response signal that includes a load shed request expressed in terms of a certain percentage reduction in the total power consumed by all of the loads controlled by the relay modules.

Load shedding logic 268 implements a technique for allocating the load shedding request equally among all of the relay modules by simply reducing the power consumed by each load by the same percentage as the load shed request. This technique assumes all of the relay modules provide analog or continuous control of their loads, e.g., dimming relay modules for lighting loads, variable speed relay modules for control of fans and other motors, etc.

Load shedding logic 270 implements a technique for systems in which all of the relays control binary (on/off) loads on circuits having roughly equal power consumption as may be the case, for example, with a relay cabinet having 32 relays, each of which controls a circuit with the same number of identical lighting loads. With this technique, the load shedding logic 270 turns off a number of loads that is roughly proportional to the percentage load shedding request. Thus, if the load shedding request is 15 percent, the load shedding logic can turn off five of the 32 lighting loads for a 15.6 percent load reduction.

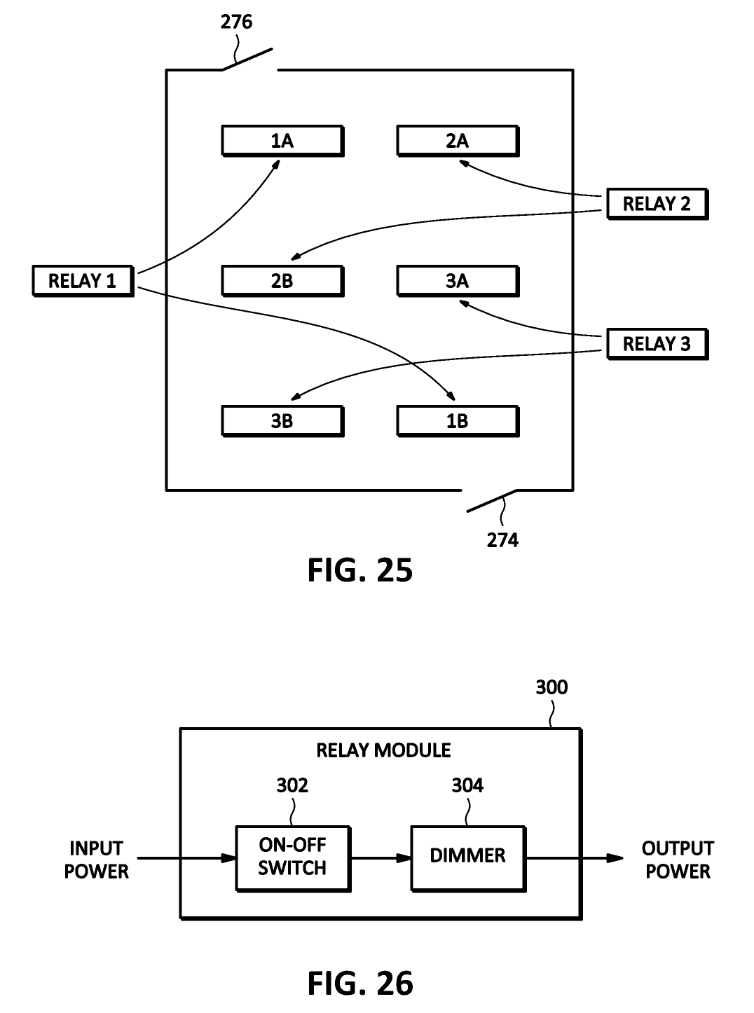

Load shedding logic 272 implements a technique similar to logic 270 for systems in which all of the relays control control binary (on/off) loads on circuits having roughly equal power consumption, but only certain relays are designated for load shedding. FIG. 25 illustrates a room floor plan for a relatively simple embodiment in which each of three relays controls two identical lighting fixtures. Fixtures 1A and 1B are controlled by Relay 1, which is not designated for load shedding because its associated fixtures are located near entryways 274 and 276. Fixtures 2A and 2B are controlled by Relay 2 and fixtures 3A and 3B are controlled by Relay 3. Of the relays that are selected for load shedding, i.e., Relays 2 and 3, the specific relays that are turned off may be preselected, selected at random, determined on a rotating basis, etc. Thus, if a 33 percent load shedding request is received, load shedding logic 272 may randomly select between turning off Relay 2 and Relay 3, may rotate between turning off Relay 2 and Relay 3 on successive occurrences, or may always turn off Relay 2.

The techniques implemented by load shedding logic 268, 270 and 272 typically would not require power metering capability in the relays because, in the case of logic 268, the percentage load reduction through each relay is uniform regardless of the actual load being drawn through the relay, whereas in the case of logic 270 and 272, the relays all control roughly the same load, so turning off a certain percentage of the relay results in roughly the same percentage reduction in the load.

Other load shedding logic may require power metering capabilities in the relays. For example, load shedding logic 278 implements a technique similar to logic 268 for systems in which all of the relays control analog or continuously controllable loads, but only certain relays are designated for load shedding. Thus, for example, if half of the relays are designated for load shedding, and a load shedding request is 10 percent, load shedding logic 278 may reduce the loads through each of the designated relays by a uniform percentage, perhaps 20 percent, that reduces the overall load through the relay cabinet by 10 percent. The load shedding logic 278 may monitor the actual power flowing through each relay and calculate a total to accurately reduce the overall load by 10 percent.

Load shedding logic 280 implements techniques that relay on priorities assigned to various loads to decide how to respond to a load shedding request. Priorities may be implemented with logic 282 that depends on the priority of specific branch circuits, logic 284 that depends on the level of power consumed by individual branch circuits, logic that depends on other factors, or any combination thereof. For example, some specific branch circuits that control accent lighting for aesthetic purposes may be given the lowest priority to remain on (highest priority to turn off) regardless of how much power they draw. Thus, upon receiving a load shedding request, load shedding logic 280 and 282 turn off relays for the branch circuits that control accent lighting, regardless of how much power they draw. As another example, some branch circuits may control relatively high-power loads such as industrial heaters, dryers, air conditioning units, etc. Upon receiving a load shedding request, load shedding logic 280 and 284 may turn off the relays for the branch circuits that are drawing the most power to realize the greatest power reduction.

Load shedding logic 268, 270, 272, 278 and 280 are shown for purposes of illustration, and countless other types of load shedding logic may be implemented according to the inventive principles of this patent disclosure, including hybrid combinations thereof shown as logic 286 in FIG. 24. Any of the logic 268, 270, 272, 278, 280 and 286 may include emergency override capabilities to turn off power or restore full power to any particular load during an emergency situation. For example, in response to a signal from a fire detection system, the logic may restore full power to light fixtures near paths of egress, which may otherwise be dimmed in response to a load shedding request, while turning off power to ventilator fans to minimize the supply of oxygen to a fire.

The demand response logic may be configured in any suitable manner according to the inventive principles of this patent disclosure. For example, the logic may be configured through a commissioning process through any suitable local inputs such as a keypad 290, touchscreen 292, etc., or remotely through a handheld display unit (HDU) 294, personal computer 296, BAS workstation 298, etc., that is connected to the control module through any suitable network.

Some additional load shedding functionality may be realized through hybrid diming/on-off relay modules according to some inventive principles of this patent disclosure. A conventional dimming relay module may operate in response to an analog control signal having a control range of 1-10 volts. At the low end of the control range, e.g., 1 volt, the associated lighting load may have essentially no light output, but still consume a significant amount of power. This is especially common with dimmable ballasts for fluorescent lamps which may consume standby power at zero light output equal to five percent of the power consumed at the highest brightness level.

FIG. 26 illustrates an embodiment of a hybrid relay module according to some inventive principles of this patent disclosure. The relay module 300 includes a binary on-off switch 302 (e.g., an air gap relay, solid state relay, etc.) connected in series with a dimming circuit 304. The on-off switch 302 enables the relay module to turn substantially completely off even when the diming circuit 304 is at the lowest power setting. The on-off switch 302 may be controlled by a control signal that is separate from the analog or digital control signal that controls the dimming circuit 304. Alternatively, logic inside the relay module may turn off the on-off switch 302 if a nominal 1-10 volt analog control signal is reduced below 1 volt, if a digital dimming control signal is reduced to a minimum value or below, or in any other suitable manner.

In an alternative embodiment, the dimming circuit 304 may be replaced by an analog or digital dimming interface that generates a dimming signal that may be used by a dimmable ballast for fluorescent or other gas-discharge lamps. In such an embodiment, the on-off switch 302 controls the input power to the ballast.

In the examples described above, load shedding is achieved through turning off a binary relay, or reducing the power level of a continuously controllable relay. In other embodiments, however, load shedding may be achieved by turning on specific relays. For example, a local power generator may be used to reduce the amount of power drawn from a utility grid. Thus, load shedding energizing a first relay that starts up a local (distributed) generator, then energizing a second relay that actuates a cross-over switch that disconnects a load from the utility grid and connects it to the local generator. As another example, available daylight may be used to replace artificial lighting that draws power from the grid. Thus, another response to a load shedding request may be to turn on a relay that opens a roller shade for natural light.

In some further embodiments, an appropriate response to a demand response signal may be increasing rather than shedding a load. This may be appropriate, for example, to burn off excess power to prevent grid instability due to a renewable energy source that is generating excess power due to natural factors such as high river levels at a hydroelectric damn or a wind storm at a wind turbine farm.

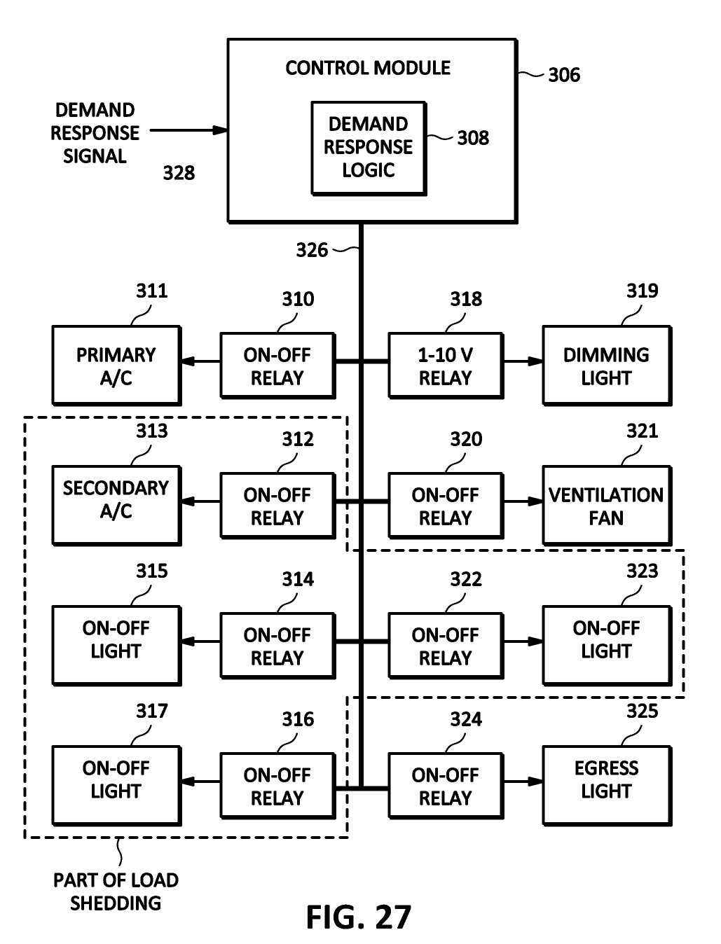

FIG. 27 illustrates an example embodiment of a relay panel system for a building that illustrates some of the inventive principles of this patent disclosure. The system of FIG. 27 includes a control module 306 that communicates with relay modules 310, 312, 314, 316, 318, 320, 322 and 324 through local control bus 326. The control module includes demand response logic 308 that decides how to control the relay modules in response to a demand response signal 328.

Relays 310 and 312 provide on-off control of a primary air conditioner 311 and a secondary air conditioner 313, respectively. Relays 314, 316 and 322 control typical on-off lighting loads 315, 317 and 323, respectively. Relay 318 provides diming control of lamps 319 in response to a photocell that implements a daylight harvesting technique, and relay 320 controls a ventilator fan 321. Relay 324 controls lighting and signage 325 for emergency egress from the building.

Relays 312, 314, 316 and 322 are commissioned for responding to a load shedding request under control of the demand response logic 308, while relays 310, 318, 320 and 324 operate independently of any load shedding request.

The primary A/C 311 provides baseline cooling and is typically adequate to cool the building to a normal air conditioning set point. The secondary A/C 313 is only activated during times of relatively high cooling loads. However, if a demand response signal is received during a time the secondary A/C 313 is running, the demand response logic 308 turns off relay 312, thereby turning off the secondary A/C 313. This may cause the building temperature to rise above the normal air conditioning set point, but the primary A/C 311 still provides adequate cooling to prevent the building temperature from becoming excessive.

Relay 318 is not part of the load shedding scheme because the lamps 319, which are controlled in response to a photocell that implements a daylight harvesting technique, would typically be dimmed because of the availability of natural light during the daytime, which is when a demand response signal for load shedding is most likely to be received.

Relay 320 is not controlled by demand response logic 308 because minimum fresh air volumes may need to be maintained even during times of peak electrical loads.

Relay 324 is not part of the load shedding scheme because it controls lighting and signage 325 for emergency egress which should be maintained regardless of a load shedding request.

The demand response logic 308 may control the typical on-off lighting loads 315, 317 and 323 in any suitable manner. For example, they may be turned off sequentially in a random or predetermined pattern until the requested amount of load has been shed. As another example, they may be assigned priorities based on the areas of the building they serve with higher priority lighting left on unless turning the lower priority lighting off does not reduce the load by an adequate amount.

An aspect of the inventive principles of this patent disclosure includes a system comprising: a relay panel; one or more relay modules mounted to the relay panel; and a control module mounted to the relay panel and configured to control the relay modules; wherein at least one of the relay modules includes a revenue-grade metering circuit to monitor power flowing through the corresponding relay module.

Some refinements are as follows. The at least one of the relay modules having a revenue-grade metering circuit includes storage to store metrology data. The at least one of the relay modules having a revenue-grade metering circuit may is adapted to transmit metrology data to the control module. The control module includes storage to store the metrology data received from the control module. The storage at the control module comprises a sliding window FIFO. The control module is adapted to transmit the metrology data to a gateway.

Another aspect of the inventive principles of this patent disclosure includes a relay module comprising: a switching device to control power to a load; a communication interface to couple the relay module to a control module at the relay panel; revenue-grade metering circuitry to monitor power flowing to the load; and a controller to control the switching device in response to inputs received at the communication interface and to transmit metrology data to the control module.

Some refinements are as follows. The revenue-grade metering circuitry is adapted to calculate one or more of the following: average voltage, RMS voltage, peak voltage, average current, RMS current, peak current, real power, apparent power, reactive power, peak power, real energy, reactive energy, power factor, line frequency, and harmonic distortion. The revenue-grade metering circuitry includes: a sensing circuit to sense the relay module voltage and current; and a metrology processor to convert the sensed voltage and current to a digitized form. The metrology processor includes a compute engine to calculate the values of metrology parameters in response to the digitized voltage and current. The relay module includes a host processor coupled to the metrology processor. The host processor includes a compute engine to calculate the values of metrology parameters in response to the digitized voltage and current. The relay module includes a zero-crossing detection circuit. The sensing circuit and the zero-crossing detection circuit are configurable. In a first configuration: the sensing circuit and metrology processor are configured to detect a zero-crossing; and the zero-crossing detection circuit is configured to sense the load voltage. In a second configuration: the sensing circuit and metrology processor are not utilized; and the zero-crossing detection circuit is configured to detect a zero-crossing. The metrology processor is configured to indicate a zero-crossing with a start bit of a data packet.

Another aspect of the inventive principles of this patent disclosure includes a method comprising: switching power to a load using a relay module at a relay panel; controlling the relay module with a control module at the relay panel; performing a revenue-grade metering operation at the relay module; and transmitting data generated by the revenue-grade metering operation from the relay module to the control module.

Some refinements are as follows. The method further comprising: storing one or more alarm thresholds at the relay module; comparing one or more computed values of metering parameters to corresponding ones of the one or more alarm thresholds; and generating an alarm when a metering parameter reaches a corresponding alarm threshold. The method further comprising switching the power to the load in response to a generated alarm.

Another aspect of the inventive principles of this patent disclosure includes a method comprising: receiving first control inputs using a first protocol at a relay panel; receiving second control inputs using a second protocol at the relay panel; translating the first control inputs to a local communication format at the relay panel; translating the second control inputs to the local communication format at the relay panel; and controlling one or more relay modules at the relay panel in response to the first and second control inputs using the local communication format.

Some refinements are as follows. The first control inputs are received from a building automation system. The first control inputs are received from a utility. The first control inputs are received from a lighting control system. The method further comprising: storing an alarm threshold at one of the relay modules; comparing a metering parameter of the one relay module to the alarm threshold; and generating an alarm at the one relay module when the metering parameter reaches the alarm threshold. The method further comprising forward the alarm to a control module at the relay panel. The method further comprising switching power to a load in response the generated alarm at the one relay module.

Another aspect of the inventive principles of this patent disclosure includes a control module comprising: a mounting interface to mount the control module to a relay panel; a first communication port to receive first control inputs using a first protocol; a second communication port to receive second control inputs using a second protocol; a third communication port to control one or more relay modules mounted to the relay panel using the local communication format; and logic to translate the first and second control inputs to the local communication format.

Some refinements are as follows. The control module further comprising storage to store metrology data received from the relay modules. The control module is adapted to transmit the metrology data to a gateway. The storage comprises a sliding window FIFO. The control module is adapted to store metrology data from the relay modules for successive time periods of a first length in a non-volatile memory at the control module. The control module is adapted to store a first number of data points for the successive time periods of the first length in the non-volatile memory. The control module is adapted to add and store a second number of the first number of data points for successive time periods of a second length in the non-volatile memory.

Another aspect of the inventive principles of this patent disclosure includes a system comprising: a relay panel; one or more mounting locations for relay modules on the relay panel; and a control module mounted to the relay panel and configured to control the relay modules; wherein the control module includes logic to translate inputs in two or more communication protocols to a local communication format to control the relay modules.

Some refinements are as follows. The local communication format comprises the Modbus protocol. The Modbus protocol operates over an RS485 physical network. The communication protocols include at least two of the following: TCP/IP, Modbus, BACnet, and Lontalk. The system further comprising one or more relay modules mounted to relay panel. One of the relay modules includes is adapted to: control the timing of an air-gap relay in response to a voltage zero-crossing when the current through the air-gap relay is below a threshold value; and control the timing of the air-gap relay in response to a current zero-crossing when the current through the air-gap relay is above the threshold value.

Another aspect of the inventive principles of this patent disclosure includes a system comprising: a relay panel; one or more relay modules mounted to the relay panel; and a control module mounted to the relay panel and configured to control the relay modules; wherein the control module include demand response logic to decide how to control the one or more relay modules in response to a demand response signal. At least one of the relays may include power metering functionality that the demand response logic uses to allocate a load shedding request received in the demand response signal.

A networked lighting control device may include a switching device to control power to a load, a communication interface to couple the relay module to a control module at the relay panel, revenue-grade metering circuitry to monitor power flowing to the load, and a controller to control the switching device in response to inputs received at the communication interface and to transmit metrology data to the control module. A control module may include a mounting interface to mount the control module to a relay panel, a first communication port to receive first control inputs using a first protocol, a second communication port to receive second control inputs using a second protocol, a third communication port to control one or more relay modules mounted to the relay panel using the local communication format, and logic to translate the first and second control inputs to the local communication format.

The inventive principles of this patent disclosure have been described above with reference to some specific example embodiments, but these embodiments can be modified in arrangement and detail without departing from the inventive concepts. Such changes and modifications are considered to fall within the scope of the following claims.

1. A system comprising:
a relay panel;
one or more relay modules mounted to the relay panel; and
a control module mounted to the relay panel and configured to control the relay modules;
wherein at least one of the relay modules includes a revenue-grade metering circuit to monitor power flowing through the corresponding relay module.

2. The system of claim 1 wherein the control module includes logic to translate first control inputs using a first protocol to a local communication format and translate second control inputs using a second protocol to the local communication format.

3. The system of claim 1 wherein at least one of the relay modules includes a power converter having a power transformer arranged to modulate communications through the transformer.

4. The system of claim 1 wherein at least one of the relay modules utilizes a start bit of a communication packet to signal a zero-crossing of a power signal.

5. The system of claim 1 wherein at least one of the relay modules switches between using current to sense a zero-crossing and using voltage to sense a zero-crossing of a power signal.

6. The system of claim 1 wherein at least one of the relay modules includes an illuminated actuator handle to signal a condition of the relay module.

7. The system of claim 1 wherein at least one of the relay modules includes an alarm threshold for the relay module.

8. The system of claim 1 wherein at least one of the relay modules includes first storage to store metrology data from revenue-grade metering circuit.

9. The system of claim 8 wherein the control module includes second storage to store metrology data received from the first storage at the at least one relay module.

10. The system of claim 1 wherein at least one of the relay modules measures a voltage zero-crossing on the load side of an isolation circuit.

11. A method comprising:
receiving first control inputs using a first protocol at a relay panel;
receiving second control inputs using a second protocol at the relay panel;
translating the first control inputs to a local communication format at the relay panel;
translating the second control inputs to the local communication format at the relay panel; and
controlling one or more relay modules at the relay panel in response to the first and second control inputs using the local communication format.

12. A system comprising:
a relay panel;
one or more relay modules mounted to the relay panel; and
a control module mounted to the relay panel and configured to control the relay modules;
wherein the control module include demand response logic to decide how to control the one or more relay modules in response to a demand response signal.
